(19) United States
(12) Patent Application Publication
(10) Pub. No.: US 2024/0060239 A1
(43) Pub. Date: Feb. 22, 2024

(54) DEGRADABLE AND RECYCLABLE CELLULOSE CONTAINING COMPOSITIONS AND METHODS OF MAKING THE SAME

(71) Applicant: Georgia Tech Research Corporation, Atlanta, GA (US)

(72) Inventors: Natalie Duprez, Atlanta, GA (US); Chris Luettgen, Atlanta, GA (US); Donggang Yao, Atlanta, GA (US)

(21) Appl. No.: 18/235,581

(22) Filed: Aug. 18, 2023

Related U.S. Application Data
(60) Provisional application No. 63/399,405, filed on Aug. 19, 2022.

(51) Int. Cl. D21H 19/28; D21H 27/10; C08K 3/22; D21H 21/14

(52) U.S. Cl. CPC D21H 19/28; D21H 27/10; C08K 3/22; D21H 21/14; C08K 2003/2206

(57) ABSTRACT

The present disclosure provides for a composition comprising a first layer having a first surface and a second surface and comprising a cellulosic material, wherein the first layer has a first thickness; a second layer having a first surface and a second surface, wherein the second surface of the second layer overlays the first surface of the first layer, wherein the second layer comprises a first compound comprising a first polymer and a first metal oxide, and wherein the second layer has a second thickness. Further provided herein is a method of making the same. Also disclosed herein is a an article comprising the composition provided herein. The disclosure also provides for a method of making an article from a recycled material.

### CROSS-REFERENCE TO RELATED APPLICATIONS

This application claims the benefit of priority to, and the benefit of, U.S. Provisional Application No. 63/399,405 filed on Aug. 19, 2022, the disclosure of which is hereby expressly incorporated by reference herein in its entirety.

### BACKGROUND

Polyethylene terephthalate (PET) is a petroleum-based polymer that is widely used in injection molding, blow molding, compression molding, and extrusion applications to create a water barrier. Often, PET is used as a liner material on paper packaging products. Popular applications include drinking cups, take-out food containers, and food shipping containers. In its current commercial state, PET products are not biodegradable and are mainly disposed of through landfilling and incineration.

Natural biodegradation of PET can take over hundreds of years. Natural enzymes (PETases) can aid in its degradation but requires the use of such enzymes.

There is a benefit to having single-use products that would degrade or compost naturally. There is also a need for PET-coated paper packaging to be recycled at the end of the life cycle. The methods disclosed herein address these and other needs.

### SUMMARY

In accordance with the purposes of the disclosed materials and methods, as embodied and broadly described herein, the disclosed subject matter, in one aspect, relates to polymer degradation.

Thus, in one example, a composition is provided, including a first layer having a first surface and a second surface and comprising a cellulosic material, wherein the first layer has a first thickness; and a second layer having a first surface and a second surface, wherein the second surface of the second layer overlays the first surface of the first layer, wherein the second layer comprises a first compound comprising a first polymer and a first metal oxide, and wherein the second layer has a second thickness.

In a further example, an article comprising the composition disclosed herein is provided.

Additionally, a method of making the composition disclosed herein is provided, including providing a first layer having a first surface and a second surface and comprising a cellulosic material, wherein the first layer has a first thickness; and extruding a second layer on the first surface of the first layer, wherein the second layer comprises a first compound comprising a polymer and a metal oxide, and wherein the second layer has a second thickness.

Further provided herein is a method of making an article from a recycled material, including recycling the composition disclosed herein to form the recycled material, wherein the recycled material comprises the cellulosic material of the composition; and forming the recycled material into the article.

Additional advantages will be described in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying figures, which are incorporated in and constitute a part of this specification, illustrate several aspects described below.

FIG. 1 shows a schematic of heat and mixing PET pellets to degradable PET, processing of degradable PET to an example resulting product, and degradation of the example product.

FIG. 2 shows a schematic of a process involving melt mixing and hot pressing to example PET/CaO composites, which were then degradable in water.

FIGS. 3A-3D show microscope images of example films containing PET and 10 wt % CaO after 0 minutes (FIG. 3A), after 30 minutes of degradation (FIG. 3B), after 1 hour of degradation (FIG. 3C), and after 1 day of degradation (FIG. 3D).

FIG. 4 shows FTIR spectra of degraded films with PET and 20 wt % CaO, in one aspect.

FIG. 5 shows FTIR spectra of composite films degraded in water at 90° C., in one aspect.

FIG. 6 shows the weight percentage of the specimens vs. temperature increase, in some aspects.

FIG. 7 shows an example alkaline hydrolysis reaction wherein PET reacts with water and hydroxide ions to break the ester linkages.

FIG. 8 shows an illustration of an example flash-type mold for compression molding of the PET/CaO composite films in a Carver press.

FIG. 9 shows FTIR spectra of composite films and degradation products, in one aspect.

FIGS. 10A-10F show microscope images of partially hydrolyzed example films with PET and 20 wt % CaO degraded at room temperature for 0 days (FIG. 10A), 3 days (FIG. 10B), 6 days at 100 μm (FIG. 10C), 6 days at 250 μm (FIG. 10D), 12 days (FIG. 10E), and 45 days (FIG. 10F).

FIG. 11 shows FTIR spectra of example films with PET and 30 wt % CaO degraded at room temperature.

FIG. 12 shows FTIR spectra of example degraded films with PET and 25 wt % CaO at room temperature.

FIG. 13 shows FTIR spectra of example degraded films with PET and 20 wt % CaO at room temperature.

FIG. 14 shows TGA weight curves of example films with PET and 30 wt % CaO degraded at room temperature.

FIG. 15 shows TGA derivative weight curves of example degraded films with PET and 30 wt % CaO throughout degradation at room temperature.

FIG. 16 shows PET content over time for example films with PET and 30 wt % CaO at room temperature.

FIG. 17 shows PET content over time for example films with PET and 25 wt % CaO at room temperature.

FIG. 18 shows PET content over time for example films with PET and 20 wt % CaO at room temperature.

FIG. 19 shows PET wt % over time for example films with PET and 30 wt % CaO at 60° C. and 90° C.

FIG. 20 shows PET wt % over time for example films with PET and 20 wt % CaO at 60° C. and 90° C.

FIG. 21 shows pH of water over time for example films with PET and 30 wt % CaO at room temperature.

FIG. 22 shows pH of water over time for example films with PET and 25 wt % CaO at room temperature.

FIG. 23 shows pH of water over time for example films with PET and 20 wt % CaO at room temperature.

FIGS. 24A-24B shows separation of an example specimen of plain PET (FIG. 24A) and degradable PET (FIG. 24B) from paper by peeling.

FIGS. 25A-25C shows separation of plain PET from paper: peeling apart (FIG. 25A), remaining paper after separation (FIG. 25B), and backside of PET layer after separation (FIG. 25C).

FIGS. 26A-26D shows separation of example degradable PET from paper: peeling apart (FIG. 26A), remaining paper after separation (FIG. 26B), backside of PET layer after separation (FIG. 26C), and crushed PET layer (FIG. 26D).

FIG. 27 shows a comparison of experimental and predicted PET conversion for example films with PET and 30 wt % CaO.

FIG. 28 shows a comparison of experimental and predicted PET conversion for examples films with PET and 20 wt % CaO.

FIG. 29 shows the predicted moles of each species over time for example films with PET and 30 wt % CaO.

FIG. 30 shows the predicted moles of each species over time for example films with PET and 20 wt % CaO.

FIG. 31 shows a comparison of experimental and predicted pH for example films with 30 wt % CaO.

FIG. 32 shows a comparison of experimental and predicted pH for example films with PET and 20 wt % CaO.

FIG. 33 shows experimental and predicted PET conversion for different PET/water ratios for example films with PET and 30 wt % CaO.

FIG. 34 shows experimental and predicted PET conversion or different PET/water ratios for example films with PET and 20 wt % CaO.

FIG. 35 shows a predicted effect of CaO wt % on PET conversion.

FIG. 36 shows a predicted effect of PET/water ratio on PET conversion.

FIG. 37 shows a predicted effect of film thickness on PET conversion.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

For the terms “for example” and “such as,” and grammatical equivalences thereof, the phrase “and without limitation” is understood to follow unless explicitly stated otherwise.

As used in the specification and the appended claims, the singular forms “a,” “an” and “the” include plural referents unless the context clearly dictates otherwise. Thus, for example, reference to “a compound,” or “a composition,” includes, but is not limited to, two or more such compounds, or compositions, and the like.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

Other than in the examples, or where otherwise noted, all numbers expressing quantities of ingredients, reaction conditions, and so forth used in the specification and claims are to be understood at the very least and not as an attempt to limit the application of the doctrine of equivalents to the scope of the claims, to be construed in light of the number of significant digits and ordinary rounding approaches. Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges and individual numerical values within that range. Thus, for example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

“Optional” and “optionally” means that the subsequently described event or circumstance may or may not occur and that the description includes instances where said event or circumstance occurs and instances where it does not.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed, and the processing conditions observed. Thus, it is not always possible to specify an exact “effective amount” or “condition effective to.” However, it should be understood that an appropriate, effective amount will be readily determined by one of ordinary skill in the art using only routine experimentation.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

As used herein, the term “substantially,” in, for example, the context “substantially identical” or “substantially similar” refers to a method or a product, or an article, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term “substantially free,” when used in the context of a composition or component of a composition that is substantially absent, is intended to refer to an amount that is then about 1 wt % or less, e.g., less than about 0.5 wt %, less than about 0.1 wt %, less than about 0.05 wt %, or less than about 0.01 wt % of the stated material, based on the total weight of the composition.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition or article denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5 and are present in such ratio regardless of whether additional components are contained in the composition.

A weight percent of a component, or weight %, or wt %, unless specifically stated to the contrary, is based on the total weight of the formulation or composition in which the component is included.

The term “polymer” may comprise homopolymers, copolymers, such as, for example, block, graft, random, and alternating copolymers, terpolymers, etc., and blends and modifications thereof. Furthermore, unless otherwise specifically limited, the term “polymer” shall include all possible structural isomers; stereoisomers including, without limitation, geometric isomers, optical isomers, or enantiomers; and/or any chiral molecular configuration of such polymer or polymeric material. These configurations include but are not limited to isotactic, syndiotactic, and atactic configurations of such polymer or polymeric material.

### Chemical Definitions

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acetal, acyl, alkyl, alkoxy, alkenyl, alkynyl, aryl, heteroaryl, aldehyde, amino, cyano, carboxylic acid, ester, ether, carbonate ester, carbamate ester, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is in no way intended that an order be inferred in any respect. This holds for any possible non-express basis for interpretation, including matters of logic concerning the arrangement of steps or operational flow, plain meaning derived from grammatical organization or punctuation, or the number or type of aspects described in the specification.

The present invention may be understood more readily by reference to the following detailed description of various aspects of the disclosure and the examples included therein, and their previous and following description.

### Composition

Provided herein is a composition comprising: a first layer having a first surface and a second surface and comprising a cellulosic material, wherein the first layer has a first thickness; a second layer having a first surface and a second surface, wherein the second surface of the second layer overlays the first surface of the first layer, wherein the second layer comprises a first compound comprising a first polymer and a first metal oxide, and wherein the second layer has a second thickness.

Cellulosic material refers to an agricultural or wood feedstock comprising cellulose, hemicellulose, lignin, or a combination thereof. Cellulosic material can include bagasse, straw, paper, cardboard, wood, hemp, giant reed, or eucalyptus tree, for example.

A polymer is a substance or material comprising macromolecules made up of repeating subunits. Polymers can be natural or synthetic and are created via polymerization of smaller molecules. Their large molecular mass in comparison to small molecular compounds provides physical properties such as toughness, high elasticity, viscoelasticity, and the ability to form amorphous and semi-crystalline structures rather than crystals.

Metal oxides are crystalline solids that contain a metal cation and an oxide anion. Metal oxides can be found in nature as minerals and can be formed by oxidation of metals. In some examples, metal oxide can include CaO, MgO, FeO₄, BaO, ZnO, or any combination thereof.

In some examples, the first polymer comprises a polyolefin, a polyamide, a polyester, or any combination thereof.

In some examples, polyolefins are derived from a small set of simple olefins, such as alkenes. Polyolefins can further include thermoplastic polyolefins and polyolefin elastomers, for example. Examples of thermoplastic polyolefins include low-density polyethylene (LDPE), linear low-density polyethylene (LLDPE), very-low-density polyethylene (VLDPE), ultra-low-density polyethylene (ULDPE), medium-density polyethylene (MDPE), polypropylene (PP), polymethylpentene (PMP), polybutene-1 (PB-1), ethylene-octene copolymers, stereo-block PP, olefin block copolymers, and propylene-butane copolymers, for example. Polyolefin elastomers can include polyisobutylene (PIB), poly(a-olefin)s, ethylene propylene rubber (EPR), and ethylene propylene diene monomer (M-class) rubber (EPDM rubber).

A polyamide is a polymer with repeating units linked by amide bonds. Polyamides can occur both naturally and artificially. Examples of naturally occurring polyamides include proteins such as wool and silk, for example. Artificially made polyamides can be made through step-growth polymerization or solid-phase synthesis yielding materials such as nylons, aramids, and sodium polyaspartate. Polyamides include aliphatic polyamides, polyphthalamides, or aromatic polyamides, for example. Aliphatic polyamides can include nylon PA 6 and PA 66, for example.

A polyester is a polymer that contains the ester functional group in units of the main chain. Polyesters can include naturally occurring chemicals, as well as synthetic materials. Synthetic polyesters can include linear aliphatic high molecular weight polyesters, aliphatic linear low-molar-mass hydroxy-terminated polyesters, hyperbranched polyesters, aliphatic-aromatic polyesters, aromatic linear copolyesters, or unsaturated polyesters, for example. Specific polyesters can include poly(ethylene terephthalate) (PET), poly(butylene terephthalate) (PBT), poly(hexamethylene terephthalate) (PHT), and poly(propylene terephthalate) (PTT), for example.

In some examples, the first metal oxide is selected from CaO, Na₂O, K₂O, Li₂O, BaO, SrO, MgO, or a combination thereof. In some examples, the first metal oxide is present in the first compound in a weight percentage of from 5 wt % to 50 wt % of the total weight of the first compound. In some examples, the first metal oxide is present in the first compound in a weight percentage of from 5 to 10, 10 to 15, 15 to 20, 20 to 25, 25 to 30, 30 to 35, 35 to 40, 40 to 45, or 45 to 50 wt % of the total weight of the first compound. In further examples, the first metal oxide is present in the first compound in a weight percentage of from 10 to 20, 20 to 30, 30 to 40, or 40 to 50 wt % of the total weight of the first compound. In certain examples, the first metal oxide is present in the first compound in a weight percentage of from 5 to 25, or 25 to 50 wt % of the total weight of the first compound. In specific examples. the first metal oxide is present in the first compound in a weight percentage of from at least 5, 10, 15, 20, 25, 30, 35, 40, 45, or 50 wt % of the total weight of the first compound.

In some examples, the composition is at least partially degradable in an aqueous environment. In such examples, degradability of the composition can be tunable based on the weight percentage of the first metal oxide present in the first compound. It is understood that the reference to the “aqueous environment” includes any environments comprising at least some of the moisture present. For example, a humid soil or general humid atmosphere would be considered “aqueous environment.” In still further aspects, any atmosphere comprising more than 0% humidity would be considered an “aqueous environment.”

As used herein, degradable refers to the ability of a material to decompose in a surrounding environment, which can include, for example, an aqueous environment or a natural environment (e.g., “biodegradable”). A degradable material breaks down into smaller compounds and components and eventually into simple compounds, such as carbon dioxide, water, and oxygen, for example. A partially degradable material can include a material in which a portion of the material decomposes, or breaks down, to simple compounds, or a material in which all or a portion of the material breaks down into compounds or components smaller than the original material, but in some examples not simple compounds such as water, carbon dioxide, or oxygen.

Tunable as used herein refers to the ability of the claimed composition to have its degradability modified as desired. In some examples, tunable refers to the ability to modify the amount of time for the composition to degrade. As detailed in the Examples, the amount of time for degradation corresponds to the weight percentage of the first metal oxide in the first compound. By altering that weight percentage, the rate at which the composition degrades also changes and can be modified such that the resulting composition can be used for varying applications. The tunable nature of the claimed composition results in a composition that will not degrade while in use before becoming waste but will degrade after use when discarded as waste.

In some examples, the second thickness is smaller than the first thickness. In further examples, the first thickness is from 0.0001 to 0.01 inches. In certain examples, the first thickness is from 0.0001 to 0.0002 inches, 0.0002 to 0.0003 inches, 0.00003 to 0.0004 inches, 0.0004 to 0.0005 inches, 0.0005 to 0.0006 inches, 0.0006 to 0.0007 inches, 0.0007 to 0.0008 inches, 0.0008 to 0.0009 inches, or 0.0009 to 0.001 inches. In specific examples, the first thickness is from 0.001 to 0.002 inches, 0.002 to 0.003 inches, 0.003 to 0.004 inches, −0.004 to 0.005 inches, 0.005 to 0.006 inches, 0.006 to 0.007 inches, 0.007 to 0.008 inches, 0.008 to 0.009 inches, or 0.009 to 0.01 inches. In some examples, the first thickness is from 0.0008 to 0.002 inches. In further examples, the first thickness is from 0.0008 to 0.00085 inches, 0.00085 to 0.0009 inches, 0.0009 to 0.00095 inches, 0.00095 to 0.0010 inches, 0.0010 to 0.0015 inches, 0.0015 to 0.0020 inches. In certain examples, the first thickness is from 0.0009 to 0.00092 inches, 0.00092 to 0.00094 inches, 0.00094 to 0.00096 inches, 0.00096 to 0.00098 inches, 0.00098 to 0.0010 inches, 0.0010 to 0.0012 inches, 0.0012 to 0.0014 inches, 0.0014 to 0.0016 inches, 0.0016 to 0.0018 inches, or 0.0018 to 0.0020 inches.

In further examples, the first thickness is from 0.0001 to 0.01 inches. In certain examples, the second thickness is from 0.0001 to 0.0002 inches, 0.0002 to 0.0003 inches, 0.00003 to 0.0004 inches, 0.0004 to 0.0005 inches, 0.0005 to 0.0006 inches, 0.0006 to 0.0007 inches, 0.0007 to 0.0008 inches, 0.0008 to 0.0009 inches, or 0.0009 to 0.001 inches. In specific examples, the second thickness is from 0.001 to 0.002 inches, 0.002 to 0.003 inches, 0.003 to 0.004 inches, −0.004 to 0.005 inches, 0.005 to 0.006 inches, 0.006 to 0.007 inches, 0.007 to 0.008 inches, 0.008 to 0.009 inches, or 0.009 to 0.01 inches. In some examples, the second thickness is from 0.0008 to 0.002 inches. In further examples, the second thickness is from 0.0008 to 0.00085 inches, 0.00085 to 0.0009 inches, 0.0009 to 0.00095 inches, 0.00095 to 0.0010 inches, 0.0010 to 0.0015 inches, 0.0015 to 0.0020 inches. In certain examples, the second thickness is from 0.0009 to 0.00092 inches, 0.00092 to 0.00094 inches, 0.00094 to 0.00096 inches, 0.00096 to 0.00098 inches, 0.00098 to 0.0010 inches, 0.0010 to 0.0012 inches, 0.0012 to 0.0014 inches, 0.0014 to 0.0016 inches, 0.0016 to 0.0018 inches, or 0.0018 to 0.0020 inches.

In further examples, the polyester comprises one or more of polyethylene terephthalate (PET), polytrimethylene terephthalate (PTT), polypropylene terephthalate (PPT), polybutylene terephthalate (PBT), copolymers thereof, and combination thereof. PET is a thermoplastic polymer resin in the polyester family.

A copolymer is a polymer made up of two or more monomers and can include block copolymers, random copolymers, alternate copolymers, and graft copolymers, for example.

In some examples, the composition further comprises a third layer having a first surface and a second surface, wherein the second surface of the third layer overlays the second surface of the first layer, wherein the third layer comprises a second compound comprising a second polymer and a second metal oxide, and wherein the third layer has a third thickness.

In further examples, the second compound is substantially the same as the first compound. In certain examples, the first polymer and the second polymer are substantially the same or substantially different. In specific examples, the first metal oxide and the second metal oxide are substantially the same or substantially different. In some examples, the second polymer comprises a second polyolefin, a second polyamide, a second polyester, or any combination thereof. In further examples, the second polyester comprises one or more of polyethylene terephthalate, polytrimethylene terephthalate, polypropylene terephthalate, polybutylene terephthalate, copolymers thereof, and combination thereof. In certain examples, the third thickness is the same or different from the second thickness.

In specific examples, the composition is configured to withstand a temperature from −10° C. to up to 160° C. without substantially degrading for a predetermined period of time. In some examples, the composition is configured to withstand a temperature from −10 to 10° C., 10 to 30° C., 30 to 50° C., 50 to 70° C., 70 to 90° C., 90 to 110° C., 110 to 130° C., 130 to 150° C., or 150 to 160° C. without substantially degrading for a predetermined period of time. In further examples, the composition is configured to withstand a temperature from −10 to 0° C., 0 to 10° C., 10 to 20° C., 20 to 30° C., 30 to 40° C., 40 to 50° C., 50 to 60° C., 60 to 70° C., 70 to 80° C., 80 to 90° C., 90 to 100° C., 100 to 110° C., 110 to 120° C., 120 to 130° C., 130 to 140° C., 140 to 150° C., or 150 to 160° C. without substantially degrading for a predetermined period of time. In certain examples, the composition is configured to withstand a temperature from at least −10° C., 0° C., 10° C., 20° C., 30° C., 40° C., 50° C., 60° C., 70° C., 80° C., 90° C., 100° C., 110° C., 120° C., 130° C., 140° C., 150° C., or 160° C. without substantially degrading for a predetermined period of time.

In some examples, the composition is configured to withstand a microwave at a frequency of 2.45 GHz without substantially degrading for a predetermined period of time. In further examples, the composition is configured to withstand a microwave at a frequency of 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, or 3.00 GHz without substantially degrading for a predetermined period of time. In certain examples, the composition is configured to withstand a microwave at a frequency of from 2.20 to 2.75, 2.25 to 2.70, 2.30 to 2.65, 2.35 to 2.60, or 2.40 to 2.55 GHz without substantially degrading for a predetermined period of time. In specific examples, the composition is configured to withstand a microwave at a frequency of from 2.40 to 2.50, 2.42 to 2.48, 2.43 to 2.47, or 2.44 to 2.46 GHz without substantially degrading for a predetermined period of time.

In some examples, the composition is substantially recyclable. Recyclable refers to the ability of a material to be processed into new materials and objects. In some examples, the new materials and objects can include paper, paper products such as plates, cups, cardboard, and packaging materials, for example.

In some examples, at least 75 wt % of an original amount of the cellulosic material is recoverable. Recoverable refers to the ability of a material, or a component of the material, to be regained or retrieved. In some examples, the cellulosic material of the claimed composition is recoverable for further applications. In further examples, the cellulosic material is recoverable after a process to remove the second layer and/or the components thereof.

In some examples, from 50-55%, 55-60%, 60-65%, 65-70%, 70-75%, 75-80%, 80-85%, 85-90%, 90-95%, or 95-100% of an original amount of the cellulosic material is recoverable. In further examples, at least 50%, 55%, 60%, 65%, 70%, 75%, 80%, 85%, 90%, or 95% of an original amount of the cellulosic material is recoverable. In certain examples, at least 71%, 72%, 73%, 74%, 75%, 76%, 77%, 78%, or 79% of the cellulosic material is recoverable.

In some examples, the first polymer comprises polyethylene terephthalate and the first metal oxide comprises CaO. However, it is understood that any other alkali or alkaline-earth oxide can be used.

In some examples, the polymer and the metal oxide are combined via melt-mixing. Melt-mixing refers to the dispersing of particles, in some examples nanoparticles, by mechanical shearing action in the polymer matric in the molten state. In further examples, melt blending can be carried out in the presence of an inert gas, such as argon, nitrogen, or neon. In specific examples, the polymer can be dry mixed with a mixing agent or catalyst, such as an intercalant like intercalated clay, and then heated in a mixer and subject to shear sufficient to form the desired product.

In some examples, the cellulosic material comprises paper, cardboard, linerboard, containerboard, or any combination thereof.

### Article

Provided herein is an article comprising a composition of claim 1. In some examples, the article comprises a sheet material, a paper, a modified paper, a tableware, a food container, a packaging, or any combination thereof.

In further examples, the article is substantially recyclable. In certain examples, the article is configured to be heated in a microwave oven, or a convection oven up to a temperature of 200° C. without substantially degrading for a predetermined period of time. In some examples, the article is configured to be heated to a temperature of from 150-160° C., 160-170° C., 170-180° C., 180-190° C., 190-200° C., 200-210° C., 210-220° C., 220-230° C., 230-240° C., or 240-250° C. In further examples, the article is configured to be heated to a temperature of 150° C., 160° C., 170° C., 180° C., 190° C., 200° C., 210° C., 220° C., 230° C., 240° C., or 250° C.

In certain examples, the article is configured to be heated to a temperature of 175° C., 185° C., 195° C., 205° C., 215° C., 225° C.

Also provided herein is a cup comprising the composition disclosed herein. In some examples, the cup is configured to contain a cold liquid, a room temperature liquid, or a hot liquid, wherein the cup is configured substantially not to degrade for a predetermined period of time. In further examples, the article includes plates, bowls, eating utensils, and other food-related paper products.

### Method

### Method of Making the Composition

The present disclosure, in one aspect, provides for a method of making a composition comprising: providing a first layer having a first surface and a second surface and comprising a cellulosic material, wherein the first layer has a first thickness; extruding a second layer on the first surface of the first layer, wherein the second layer comprises a first compound comprising a polymer and a metal oxide, and wherein the second layer has a second thickness.

### Method of Making the Article

Also provided herein is a method of making an article from a recycled material comprising recycling the composition of claim 1 to form the recycled material, wherein the recycled material comprises the cellulosic material of the composition; and forming the recycled material into the article.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Calcium-Oxide PET Composite

Calcium-oxide (CaO)-PET composite has been formed by combining calcium-oxide (CaO) powder via a melt-mixing process to generate a catalyst-assisted polyethylene terephthalate mixture that can be formed into a coating layer on paper or paper-like substrates, e.g., drinking cups, take-out food containers, and food shipping containers. The catalyst-assisted polyethylene terephthalate mixture was extruded as a coating onto a paper substrate to which the CaO remains latent in the PET structure. In some aspects, the catalyst-assisted polyethylene terephthalate mixture was employed in the conventional manufacturing process to fabricate PET-based coffee cups, take-out food containers, and food shipping containers, and the like product

Once the paper or paper-like substrates with the catalyst-assisted polyethylene terephthalate mixture are immersed in water, the catalyst-assisted polyethylene terephthalate mixture would degrade, via hydrolysis, to a nontoxic terephthalate salt (CaTP) that would result in a break-up of the paper or paper-like substrates.

FIG. 1 shows a high-level process of forming degradable PET from PET pellets. The degradable PET can then be processed into and employed as a coating for paper or paper-like products that can then be naturally degraded by water.

Because paper and plastic are difficult to separate once fused/manufactured, most are often discarded in landfills or are incinerated. In worst-case scenarios, they end up in the ocean. The catalyst-assisted polyethylene terephthalate mixture provides an economically viable solution for paper cup recycling.

### Method of Fabrication

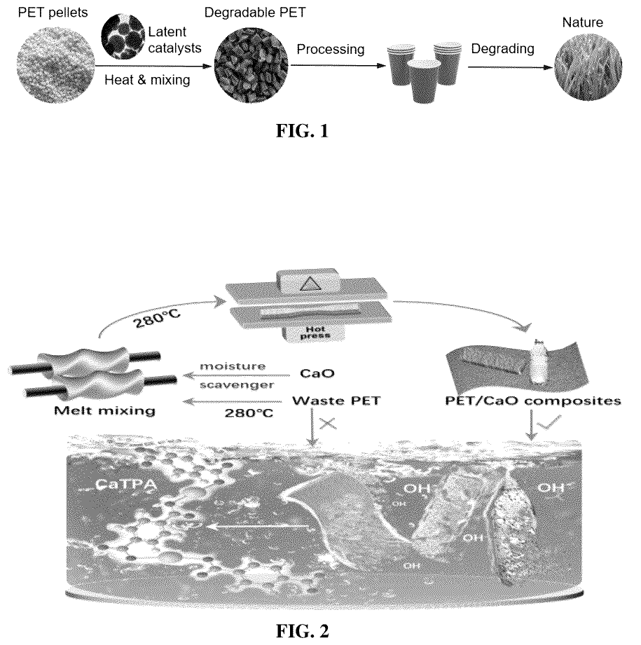

FIG. 2 shows an example method of fabrication of the catalyst-assisted polyethylene terephthalate mixture and the resulting paper or paper-like product.

In the example of FIG. 2, PET (e.g., PET pellets) and CaO (e.g., CaO pellets) are melted and mixed at 280° C. to form a composite (e.g., for 15 min). The resulting composite material can then be pressed into films via compression molding. In some embodiments, the film can be 0.001″ thick. The mixed composite can have a 10 wt % CaO, 20 wt % CaO, or 30 wt % CaO. The concentration of CaO (i.e., a ratio of CaO and PET) can vary the effective degradation rate of the product.

### Example Products

The catalyst-assisted polyethylene terephthalate (PET) with CaO can be fabricated into coffee cups, take-out food containers, and food shipping containers. The coating can be applied to the interior surface of the products in some embodiments. In some embodiments, the coating can be applied to the interior and the exterior of the products.

For coffee cups, take-out food containers, and food containers intended to handle cold liquid or food (e.g., less than ambient temperature), the coating can be applied to the interior surface of the product. For coffee cups, take-out food containers, and food containers intended for handling hot liquid (e.g., greater than ambient temperature), the coating can be applied to the interior surface and the exterior surface of the product.

### Experimental Results and Example

Described herein is an experiment to evaluate the degradation characteristics of catalyst-assisted polyethylene terephthalate mixture comprising CaO. In the experiment, multiple thick films (˜0.001″) were assessed, at different CaO wt % concentrations. The composite films were degraded in water at 90° C. for varying amounts of time: 30 minutes, 1 hour, and 1 day. It was observed that significantly faster degradation can be observed for higher CaO concentrations.

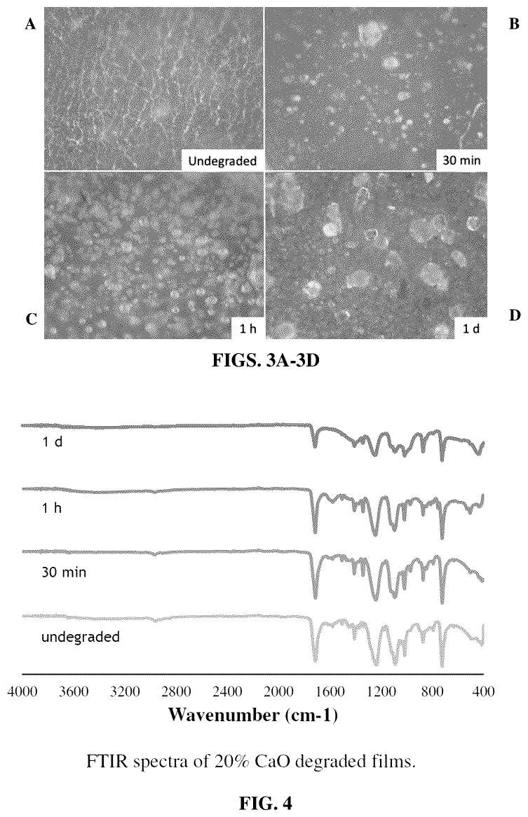

Degradation Kinetics. The study also evaluated the degradation kinetics and concluded that catalyst-assisted polyethylene terephthalate mixture with CaO can be controlled by varying the CaO concentration. It was found that films comprising 30 wt % of CaO f degrade in about 2 days, while the films comprising 10 wt % of CaO are not able to fully degrade in an appreciable time frame. FIG. 3A-FIG. 3D show observed surface changes of the catalyst-assisted polyethylene terephthalate mixture with CaO for a 10 wt % CaO mixture.

Puncture Test. The experiment also evaluated the change in mechanical properties of the catalyst-assisted polyethylene terephthalate mixture. A puncture test was performed. Table 1 shows the experimental results of the puncture test.

TABLE 1
Puncture force at break (kg_{f}).

| wt % CaO | 10 wt % | 20 wt % | 30 wt % | 0 wt % |
|---|---|---|---|---|
| Undegraded | 6.99 | 5.11 | 1.59 | 5.79 |

| | | | | | |
|---|---|---|---|---|---|
| 30 | min | 6.70 | 3.55 | 0.90 | 5.58 |
| 1 | h | 7.30 | 4.61 | 1.15 | 5.62 |
| 1 | d | 0.70 | 0.10 | — | 4.87 |

From Table 1, it can be observed that there is a significant loss of material properties within 1 day of degradation for a 10 wt % CaO/90 wt % PET mixture, while a similar loss is observed within 30 minutes for a 30 wt % CaO/70 wt % PET mixture.

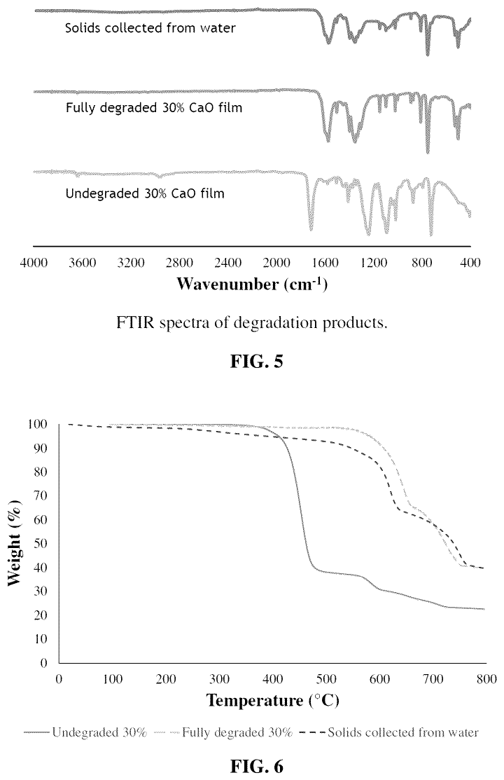

Solid fragments and powders were observed in the water. Water was collected from the degradation experiments and dried to collect the solids. This was then compared to undegraded and fully degraded films via FTIR, showing that the solids collected from the water were degradation products, as shown in FIG. 5.

Compositional changes of the films were observed using thermogravimetric analysis. There was weight loss around 450° V due to decomposition of PET, weight loss around 600° C. due to decomposition of CaTP and other organo-inorganic compounds, and weight loss around 700° C. due to decarboxylation of CaCO₃. The results are shown in FIG. 6 and indicate that the degradation produce were present in the water.

It was also observed that samples with CaO showed higher mechanical strength than virgin PET. It is understood that traditional PET-coated paper packaging is difficult to recycle due to the tough and non-degrading PET layer. If the PET layer is degradable, one can degrade the PET layer in hot water and then re-pulp the paper substrate into reusable cellulose fibers. In the case of coated paper packaging products, one important task in recycling is to recover paper fibers from the waste product. This is often down by mechanical pulping processes. For paper packaging with non-degradable polymer coating, the separation of polymer is a huge challenge, therefore discouraging the recycling effort (low efficiency and low recovery rate, thus low economics). With PET/CaO used as a coating, the wastepaper packaging product can be cooked in hot water for a designated time, and after PET degrades (or become brittle), mechanical pulping can be readily conducted.

### Example 2: Processing, Degradation, and Characterization of PET/CaO Composites

### Introduction

In order to create a cost-effective, fully degradable plastic, a process is proposed for melt-mixing PET with CaO, which is an alkaline reagent that remains unreactive until exposed to water. Latent degradation with CaO is more complex, since rather than exposing the PET to an alkaline solution, the alkaline reagent is dispersed in the PET, and it is first be activated by water before PET degradation can begin.

In this work, the conversion of CaO to Ca(OH)₂ is taken to be the first step of the latent degradation mechanism. The newly formed Ca(OH)₂ is then proposed to dissolve in the water, creating a strongly alkaline environment. From there, the PET undergoes conventional alkaline hydrolysis, reacting with the water and hydroxide ions at the surface to break the ester linkages.

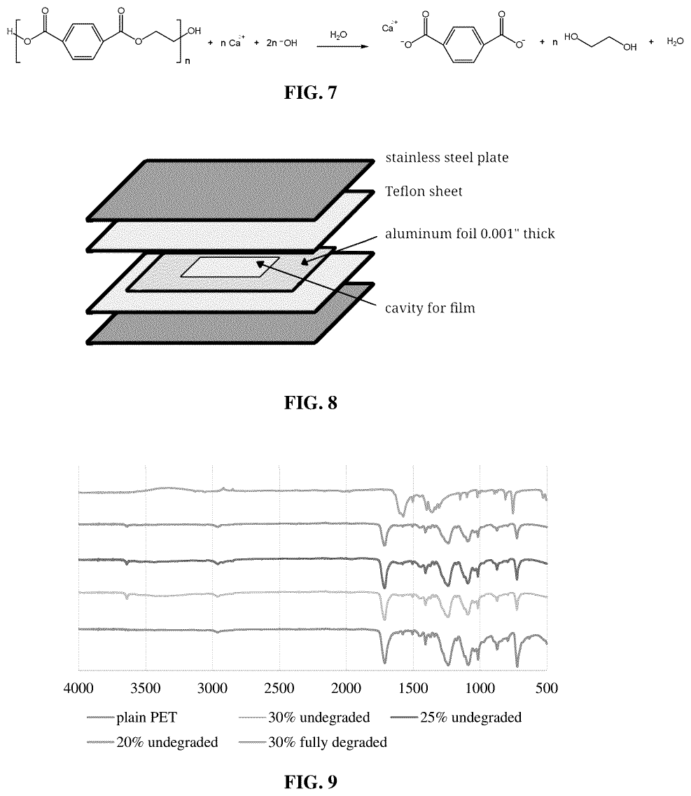

The proposed reactions are shown below and in FIG. 7.

CaO(s)+H₂O(l)→Ca(OH)₂(s)

Ca(OH)₂(s) [symbol] Ca²⁺(aq)+2OH⁻(aq)

The degradation of this PET/CaO composite material is studied herein in order to validate the proposed mechanism. This is done by preparing composite films of different CaO concentrations and degrading them in water for various amounts of time. Testing and characterization techniques are used to determine the extent of degradation of the PET throughout the reaction, as well as observing the general behavior of other species involved in the reaction. The products resulting from complete hydrolysis of the material are characterized to verify the presence of the expected products.

### Materials and Experimental Methods

### Materials

Fiber/extrusion grade PET pellets of IV 0.83 were obtained from the former Kosa Company (now part of the Invista Company). Calcium oxide powders (SKU #C0892-500G) manufactured by Aqua solutions (Deer Park, TX 77536) were obtained from Sigma-Aldrich.

### Batch Mixing

Melt mixing was used to combine the PET and CaO. A C. W. Brabender Prep-Center 300 cm³ batch mixer fitted with twin roller blades was used for this. All materials were dried beforehand. Typical protocol dictates that the PET is dried for at least 4 hours at 150° C. in a convective oven, but this was done for 24 hours here. PET is known to undergo thermal and hydrolytic degradation at its melt processing temperature if moisture is present, so thorough drying is necessary. The CaO powders were dried for at least 4 hours at 450° C. in a convective furnace. This elevated temperature is necessary because stored CaO powders may react with moisture in the air to form Ca(OH)₂, which is known to initiate hydrolysis in PET during melt mixing, even without the presence of water.

The PET pellets were first added gradually to the batch mixer at 5 rpm and allowed to melt. The CaO powders were then added gradually. The mixing speed was increased to 25 rpm and it was allowed to mix for 15 min. After mixing, the PET/CaO composite was removed. Three batches were mixed for each concentration of CaO, including 20%, 25%, and 30%. One batch of plain PET was mixed as a control. For the control, although CaO powders were not added, the PET was mixed for the same amount of time, using the same mixing speeds.

### Compression Molding

A Carver press (Model: #4389 MOD-M) with 9″×9″ heated platens was used for compression molding of the PET composite films. Before preparing the films, the composite material was ground into small pieces using a burr grinder and dried for at least 4 hours at 150° C. in a convection oven.

A flash-type mold was prepared (FIG. 8). Aluminum foil was used with a 0.001″ thickness in order to create PET films of the same thickness. A 3×3″ square was cut into the foil, and this was sandwiched between two pieces of Teflon. Ground composite was measured to 2.25 g and placed in the square hole of the mold, between the two pieces of Teflon. This was placed in the Carver press at 280° C., and the composite was allowed to melt for about 20-30 s before the press was closed and pressure was slowly applied, until the total force reached about 10 metric tons. The sample was left there for about 15 s in order to allow the PET to completely fill the cavity. The mold was then removed and allowed to cool, and the film was removed.

### Degradation of Composite Films in Water

The PET composite films were degraded in sealed bottles of water for varying amounts of time, then the solids were filtered, dried, and weighed. In each bottle, 20 g of DI water was measured. The bottles were sealed and placed in the oven or left out at room temperature until reaching the desired temperature. Composite films weighing about 0.50 g were measured and placed in each bottle (25 g PET/L water). The films were allowed to degrade at their respective temperatures for varying amounts of time, from as little as one hour to as long as 21 days. The samples were not stirred or agitated during the degradation.

When the film was degraded for the specified amount of time, the bottle was opened, and the contents were filtered in order to separate the solids. The pH of the water was measured using a digital pH meter. The solids were dried at 100° C. for at least 24 hours, weighed, then ground into a homogeneous powder for testing.

According to the proposed mechanism, the accumulation of hydroxide ions in the water is a step to initiating degradation, and the ratio of PET/water is one parameter of the system. For this reason, a small number of degradation experiments were repeated for each concentration at room temperature, using half the amount of PET (0.25 g) for the same amount of water. Therefore, a PET/water ratio of 25 g/L was mainly used during degradation, with a smaller number of samples degraded at 12.5 g/L.

### Testing and Characterization Methods

### Fourier Transform Infrared Spectroscopy (FTIR)

Fourier transform infrared spectroscopy was performed using a Thermo Scientific Nicolet™ iS5 FTIR spectrometer equipped with an OMNIC™ software package. The samples were scanned 20 times with a resolution of 4 cm⁻¹, and an iD7 ATR accessory with diamond crystal was used to measure the transmittance spectra of the samples with adsorbed pyridine.

### Thermogravimetric Analysis (TGA)

Thermogravimetric analysis was performed using a TA Instruments TGA Q50. Samples were heated from 30° C. to 110° C. with a heating rate of 10° C./min in a nitrogen atmosphere, then held at this temperature for 2 min to drive off moisture. The samples were then heated to 800° C. at a rate of 10° C./min. A platinum pan was used with approximately 15 mg of each sample.

### Microscopy

Optical microscopy was performed using a Leica DVM6 Digital Microscope. Partially and fully hydrolyzed products, ground into powders, were compressed into flat disks to create a level surface for imaging.

### Characterization of Composites and Fully Hydrolyzed Degradation Products

### Characterization Results

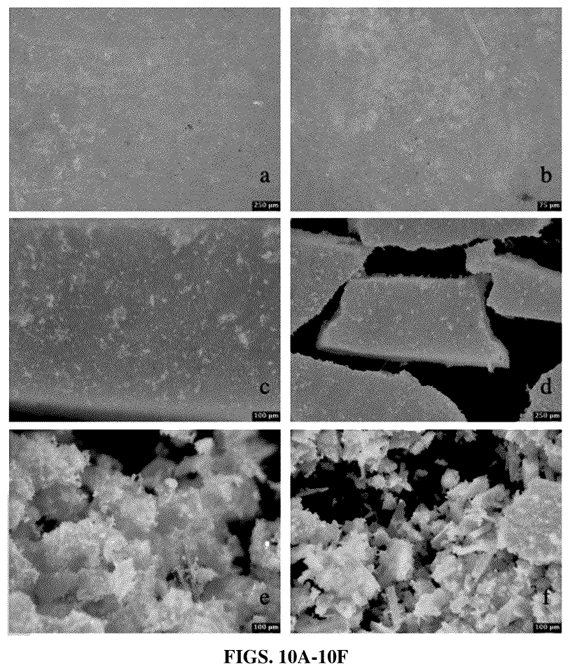

First, FTIR was used to compare the chemical structure of the composites as well as to analyze the degradation products resulting from complete hydrolysis in order to verify the presence of CaTP. These spectra are shown in FIG. 9. The undegraded composites are largely identical. They match closely with the spectrum for plain PET, except for the appearance of a small peak around 3637 cm⁻¹, which may be attributed to the CaO. The absence of any additional peaks in the spectra indicates that the composites are simply a mixture of PET and CaO, and the CaO does not act as any sort of crosslinking agent in the PET.

In Table 2, the spectra of the undegraded composites are compared with that of the fully hydrolyzed products. The peak locations for each are listed, along with what functional group that peak corresponds to, and the change that occurs at that peak as the composites are hydrolyzed.

Overall, the spectrum of the fully hydrolyzed products aligns with what is to be expected with CaTP being the main product of hydrolysis. The C—O and C═O stretching vibrations disappear, along with C—H stretching. New peaks also appear which are associated with the carboxylic deformation vibration and the carbonyl groups.

TABLE 2
FTIR analysis of composite films and degradation products.

| | Peak | | |
|---|---|---|---|
| Peak | location | | Change |
| location | (cm⁻¹) for | | during |
| (cm⁻¹) for | fully | | degra- |
| undegraded | degraded | Corresponds to | dation |
| 723 | 751 | C—H out-of-plane bending | slightly |
| | | vibration | increases |
| — | 809 | Carboxylic deformation vibration | appears |
| 845, 873, | 890, 852 | Aromatic rings 1, 2, 4, 5; tetra | decreases |
| 972 | | replaced | |
| 1016 | 1020 | C—H aromatic in-plane bending | slightly |
| | | vibration | decreases |
| 1090 | — | C—O stretching | disappears |
| — | 1095 | C—H aromatic in-plane bending | unclear |
| | | vibration | |
| 1149 | 1148 | C—H aromatic in-plane bending | increases |
| | | vibration | |
| 1237 | — | C—O stretching of terephthalate | disappears |
| | | group | |
| — | 1350 | asymmetric and symmetric | appears |
| | | carbonyl groups | |
| 1369 | 1370 | C═C stretching | increases |
| 1408 | — | Aromatic skeletal stretching band | unclear |
| 1504, | 1501, | C—C stretching, vibrations of | greatly |
| 1577 | 1571 | aromatic skeleton | increases |
| 1712 | — | C═O stretching of carboxylic acid | disappears |
| | | group | |
| 2915, | — | C—H symmetric and asymmetric | disappears |
| 2953 | | stretching | |
| 3637 | — | CaO | disappears |

### PET Degradation During Compression Molding

The composites were tested with TGA before and after compression molding in order to estimate the extent of hydrolytic and thermal degradation during processing. PET decomposes around 450° C., so the amount of the sample that is lost in that step is proportional to the mass % of PET in the sample. TGA of pure PET revealed that 80% of the PET mass is lost at that step, while the rest remains in the residue. For the composite samples, the initial mass was taken to be the mass at 325° C., and the mass after this first mass loss step was recorded at 525° C. The mass % of PET in the sample could then be estimated using the below equation.

$${x}_{P E T} = \frac{{m}_{325} - {m}_{525 ° C .}}{{m}_{325 ° C .}} * \frac{1}{0.80}$$

These values are shown in Table 3 for each concentration of CaO. Overall, the amount of thermal degradation seen in the samples during processing can be quite significant. However, this degradation decreases with increased CaO loading, indicating that CaO could have imparted some thermal stability on the PET.

TABLE 3
Weight % (wt %) of PET in composites
before and after compression molding.

| | wt % PET before | wt % PET after | |
|---|---|---|---|
| wt % CaO | compression molding | compression molding | % decrease |
| 20 | 78.9 | 70.6 | 10.6 |
| 25 | 71.5 | 67.1 | 6.15 |
| 30 | 66.5 | 64.2 | 3.46 |

### Degradation of PET/CaO Composites

### Characterization Results

Partially hydrolyzed composite films were tested in order to gain further insight into the course of the reaction. Microscope images were taken of the collected solids over the course of the degradation of 20 wt % CaO films. These images are shown in FIG. 4. Before degradation, the films start with a yellow color and a relatively untextured surface. Within the first 3 days, a slight crystalline texture appears on the surface, which is believed to be from the formation of calcium terephthalate (CaTP). In some places on the surface, entire crystals of CaTP were found. This increased after 6 days, and the PET breaks into fragments, such as the one shown here, which is about 1 mm in length. As the degradation continues, the composite breaks down further into powders, which become distinctly more crystalline as the reaction is allowed to progress. Microscope images of degradation after varying amount of time are shown in FIG. 10A-FIG. 10F.

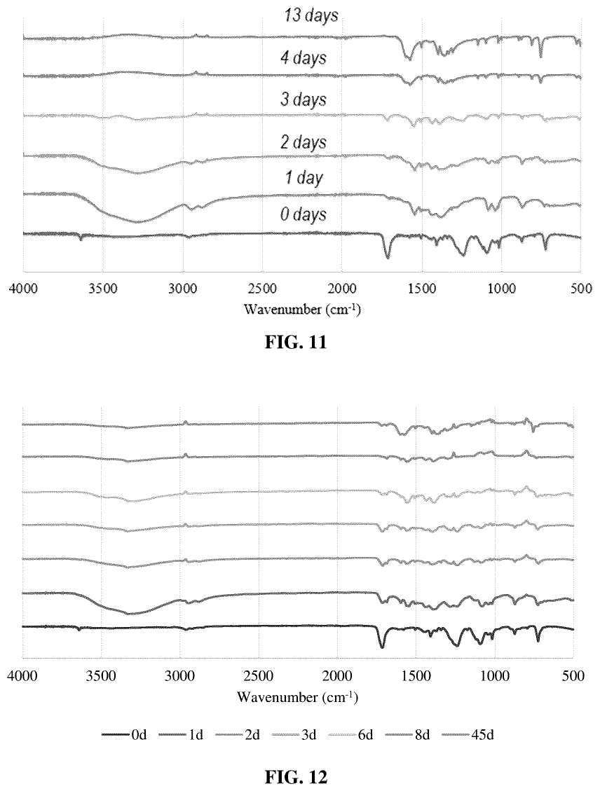

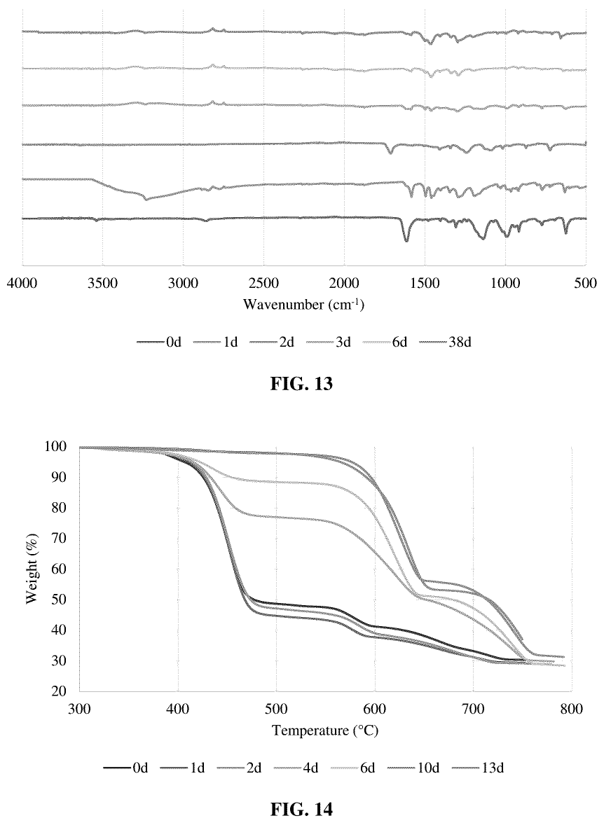

FTIR spectra of the composites throughout degradation also provide some insight into the changing composition of the films. The spectra for 30, 25, and 20 wt % CaO films are shown in FIG. 11, FIG. 12, and FIG. 13 respectively. The spectra for PET and CaTP are similar, but a transition can be seen, particularly as the C═O stretching at 1709 cm⁻¹ disappears and C—C stretching at 1571 cm⁻¹ appears. More important, however, is the appearance and disappearance of a broad peak around 3250 cm⁻¹, which is associated with absorbance of the hydroxyl group. In this case, without wishing to be bound by any theory, it was attributed to the hydroxyl group of Ca(OH)₂. The absorbance is strongest after the first day, then gradually decreases. For the 30% CaO films, it drops below detectable concentrations around the fourth day. For 20% CaO, it was gone entirely by the second day. This is fairly early in the reaction, long before PET has undergone significant degradation. Again without wishing to be bound by any theory, it was hypothesized that the newly formed Ca(OH)₂ is undergoing some other transformation rather than reacting directly with the PET. It seems most likely that the Ca(OH)₂ dissolves in the water, which then initiates hydrolysis of the PET. This dissolution would likely be slow, given the low solubility of Ca(OH)₂ and the hydrophobicity of the PET matrix, causing somewhat of a delay in the degradation reaction.

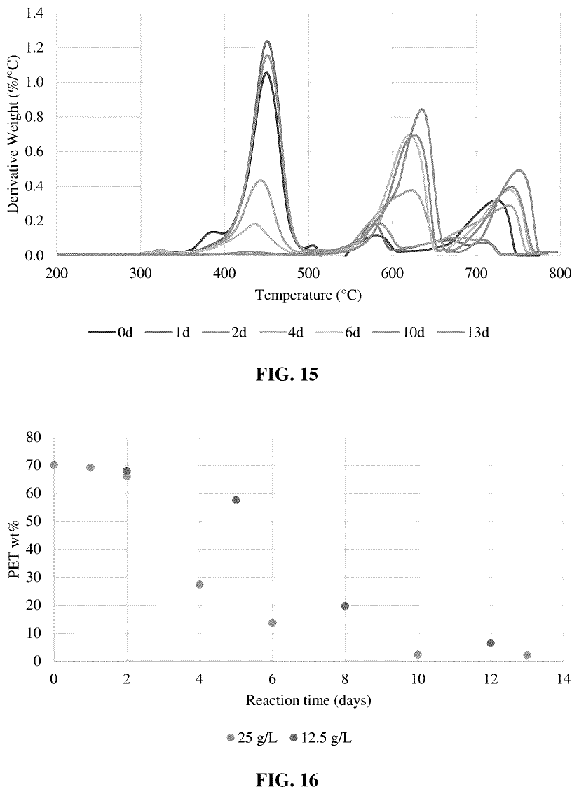

The partially hydrolyzed films were tested with TGA in order to estimate the extent of degradation. The weight and derivative weight curves are shown in FIG. 14 and FIG. 15 for the 30% CaO films. As mentioned previously, the weight loss around 450° C. is associated with the decomposition of PET. As expected, throughout the degradation, this weight loss step becomes smaller as the PET is consumed. The next weight loss step occurs between about 550° C., and 675° C., although the exact location of this step increases in temperature as the products become more degraded. This may be attributed to the decomposition of CaTP. The third weight loss step occurs between about 600° C., and 800° C., again increasing in temperature as the products become more degraded. This is attributed to the decarboxylation of CaCO₃, which is formed as a byproduct in the decomposition of CaTP. The CaO present in the solid samples is inert in this temperature range, and therefore remains in the residue.

Tracking PET Content Throughout Degradation with TGA

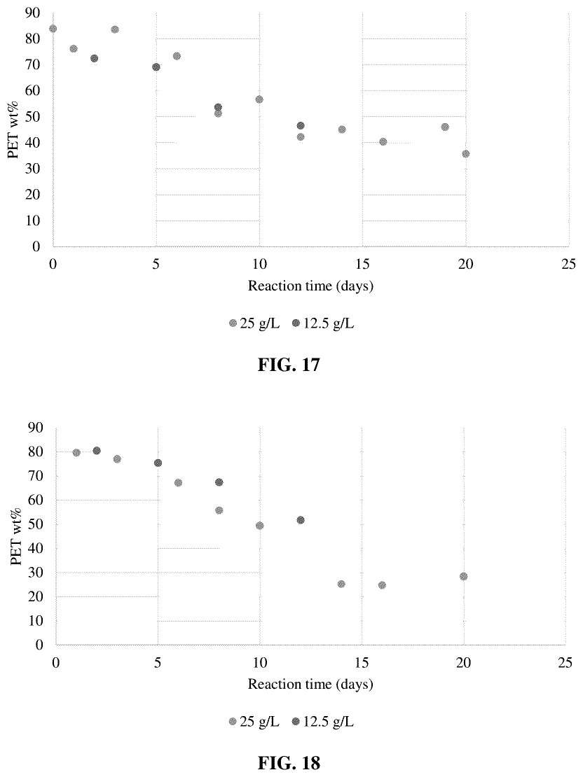

For each of the samples, the weight % of PET was estimated and this was used to track the course of the reaction. In FIG. 16-FIG. 18, the weight % of PET is shown throughout the degradation at room temperature for each concentration of CaO, including both composite film sample sizes. For all concentrations, a sort of induction period was seen at the beginning of the reaction. During the first 2 or 3 days, there is negligible degradation of the PET. After this, the PET wt % declines sharply. As expected, the 30 wt % CaO films degraded the fastest. In fact, the 30% CaO films were the only ones to fully degrade within the investigated timeframe. Degradation of the 20% CaO films slowed significantly after 14 days, and seemed to remain level around 25 wt % PET.

Based on the proposed model, there is a minimum amount of CaO that is utilized to fully hydrolyze the PET. This 1:1 molar ratio of CaO to ester linkages corresponds to a minimum of 22.6 wt % CaO in the composite. For the 20% CaO films, 14.3% of the PET is not hydrolyzed, and the final projected weight % of PET in the sample is expected to be 13.6%. The 20% CaO films were not able to reach this value in the degradation period investigated, likely because the hydroxide ions were largely consumed, reducing the driving force for the reaction.

The 25% CaO films showed more sporadic behavior, and they appeared to degrade slightly more slowly than the 20% CaO films. Without wishing to be bound by any theory it was hypothesized that this behavior could have been caused by the CaO being not well-dispersed in the PET during melt mixing, leading to inconsistencies in the degradation rate or due to some inconsistencies in film preparation associated with compression molding, possibly resulting in differences in film thickness or crystallinity which affected the degradation rate. It may also be possible that there are some nonlinear effects depending on the CaO concentration, such as end-capping or cross-linking.

For the 20 and 30% CaO films, the smaller PET/water ratio resulted in a noticeably slower degradation rate, with this difference being particularly pronounced for the 30% CaO films. According to the proposed mechanism, this is to be expected, since PET depolymerization depends on the hydroxide ion concentration in the water, and a smaller PET/water ratio results in a more diluted alkaline environment.

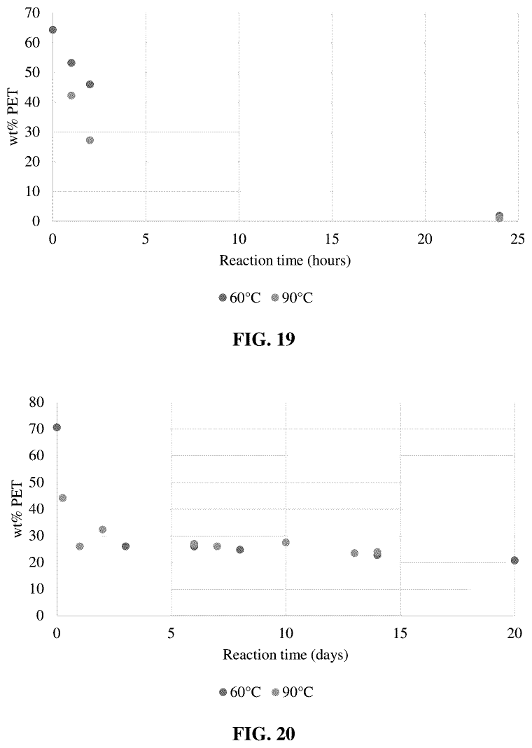

This reaction was primarily studied at room temperature, since the slower reaction kinetics allowed for better reproducibility as well as a clearer picture of the course of the reaction, particularly at the beginning with the induction period. These experiments were also performed at higher temperatures of 60 and 90° C., where the 30% CaO films degraded much more quickly (FIG. 19). Although this happened more quickly at 90° C. than at 60° C., in both cases they were able to fully degrade within 1 day. The results for the 20% CaO films are shown in FIG. 20. In this case, the films were seen to mostly degrade within the first day at 90° C. and within 3 days at 60° C. At this point, the PET content is close to 25 wt %, like what was seen at room temperature. Here, however, the PET wt % continues to decrease, approaching 20 wt % with long enough reaction times.

This slow degradation of the 20% CaO films at the end of the reaction contrasts with the behavior of the 30% CaO films, which showed a relatively fast reaction rate even toward the end of the reaction due to the excess CaO available. It seems then that CaO in excess of the stoichiometric amount aids in achieving efficient and complete hydrolysis.

### pH of Water

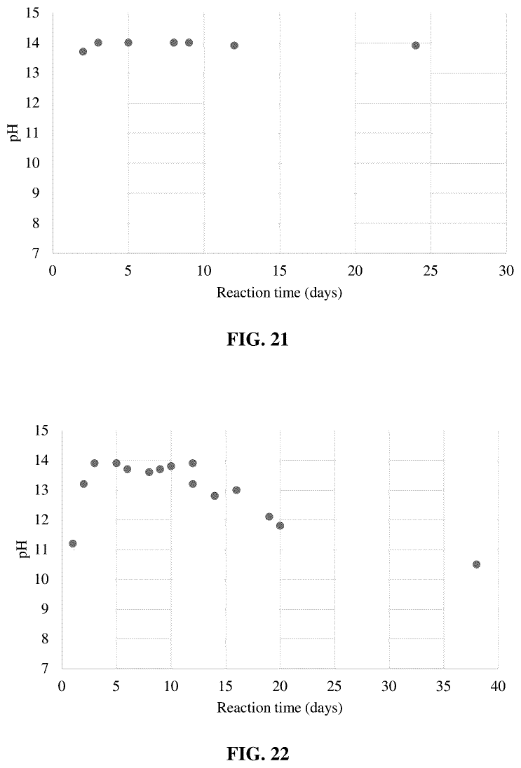

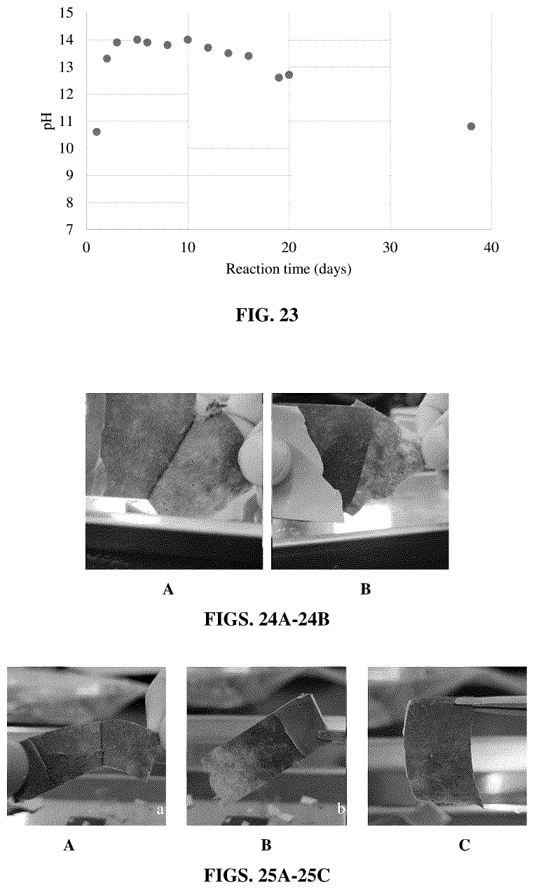

The pH of the water in the degradation experiments was also recorded in order to observe the behavior of the intermediate hydroxide ion (FIG. 21-FIG. 23). The presence of CaO in the composite results in a highly basic environment throughout the degradation reaction. A very rapid increase is seen at the beginning, within the first few days of degradation. For all concentrations of CaO, the pH reaches 14, which is the maximum that can be detected using this pH meter, and it remains around that level for much of the reaction. The 30% CaO films remain around this pH for the entirety of the reaction, due to the excess of CaO available. The 20 and 25% CaO films, however, both show a decrease in pH after about 10 days. This decrease in the pH is to be expected, since 2 OH— ions are consumed for each ester linkage in the PET that is broken.

### Discussion

These results showed that PET/CaO composite films are able to be fully degraded in water, producing CaTP as the main product. It was found that 30 wt % CaO films degrade completely within a few weeks. The 20 wt % films underwent the majority of their degradation during the first 2 weeks, then slowed significantly with about 25 wt % PET remaining. Past this point, the reaction continued, as seen with the higher temperature experiments, at a slower rate. Again, without wishing to be bound by any theory, it was assumed that the excess of CaO present in the composition in an amount greater than stoichiometrically required, can assist in achieving complete hydrolysis faster.

For degradation of these films at room temperature, an induction period was observed at the beginning of reaction, since the CaO must first be activated by water in order to create an alkaline environment to initiate degradation. For all CaO concentrations, this induction period was about 2-3 days long. This is a unique feature of latently degradable PET. Although it is fully degradable in water, there is some short-term resistance to degradation, which may allow for this material to be used in the presence of water for a short time before failure of the material occurs.

The generation and consumption of the intermediate species, Ca(OH)₂ and OH⁻, has provided evidence for the validity of the proposed mechanism. The hydroxide groups of the Ca(OH)₂ were detectable with FTIR, and the concentration of this species was strongest after 1 day of degradation for each concentration. This peak then gradually decreased and was gone by the 4^{th} day, indicating that Ca(OH)₂ is dissolved to below detectable levels long before complete degradation is able to take place.

It was generally observed that increased loading of CaO resulted in faster degradation, as expected. Higher loadings of CaO were also seen to improve the thermal stability of PET, and less degradation was observed. This is consistent with what has been previously reported for this material.

In certain aspect, it was found that the films containing higher concentrations of CaO are more brittle. A similar decrease in strength was observed previously with 40% CaO composites.

### Conclusions

Without wishing to be bound but what is detailed herein, this example describes the latent alkaline hydrolysis mechanism wherein CaO is converted to Ca(OH)₂, which dissolved in water, creating an alkaline environment for hydrolysis.

### Example 3: Paper Coated with Degradable PET

### Introduction

The goal of this example was to gain an understanding of the mechanism by which latently degradable PET is able to undergo hydrolysis when exposed to water. Very little flexible packaging is recycled, meaning that the majority of it is landfilled, incinerated, or simply unaccounted for. Additionally, many films already utilize polymers with low molecular weights, which makes them poor candidates for mechanical recycling, since it causes such significant degradation in the recycled material.

While films represent a large portion of the flexible packaging that is part of this problem, another significant component is the application of polymer coatings on paper, most often for the purpose of providing a water barrier. Polymer-coated paper has the advantage of using much less plastic, with the majority of its strength coming from the degradable paperboard. However, the strong adhesion between the paper and polymer also prevents the paper from being effectively recycled. Many recycling facilities do not accept polymer-coated paper, since it was widely believed that the polymer lining would clog or otherwise disrupt the equipment. Some of the paper fiber is able to be recovered, but it was clear that some of the yield was lost because the fibers were not able to separate from the plastic.

While plain PE and PET coatings are not able to be efficiently separated from paper fibers, latently degradable PET was able to separate more easily once significant enough surface-level degradation occurred. This allowed for a coating which offered temporary water resistance yet was able to be completely removed to allow the paper, or possibly both materials, to be recycled. Latent degradation refers to the phenomenon wherein a catalyst or reagent in a composite material becomes active when the composite material is exposed to an aqueous environment.

Herein, latently degradable PET was applied as a coating to paper, and these samples were soaked in water in order to observe the behavior of a degradable PET coating and its adhesion to the paper substrate. This was done to demonstrate the potential for recycling paper coated with degradable PET.

### Materials and Methods

### Materials

Unbleached Kraft paper was used as the paper substrate. Fiber/extrusion grade PET pellets of IV 0.83 were obtained from the former Kosa Company (now part of the Invista Company).

### Preparation of PET Coated Paper Using Compression Molding

In order to prepare paper samples coated with degradable PET, compression molding was performed using a Carver press (Model: #4389 MOD-M) with 9″×9″ heated platens.

In these tests, 20% CaO composites were used. Before preparing the films, the composite was ground into small pieces using a burr grinder and dried for at least 4 hours at 150° C. in a convection oven. A flash type mold was prepared identical to one described in section 3.1 for creating 0.001″ films. Ground composite was measured to 2.25 g and placed in the square hole of the mold, between the two pieces of Teflon. This was placed in the Carver press at 280° C., and the composite was allowed to melt for about 20-30 s before the press was closed and pressure was slowly applied, until the total pressure reached about 10 metric tons. The sample was left there for about 15 s in order to allow the PET to completely fill the cavity. The mold was then removed, and the film was allowed to cool enough to remove the Teflon on one side. The remainder of the mold was placed back in the Carver press, with the Teflon on the bottom and the composite face-up. The composite was allowed to melt again, which required 5-10 seconds.

A square piece of Kraft paper, cut slightly smaller than the opening of the flash-type mold, was placed on top of the molten composite. The Teflon was replaced, and pressure was applied evenly with an unheated tool in order to achieve satisfactory adhesion between the paper and composite. The entire mold was then removed and placed under a steel plate to cool. This same process was used to prepare paper samples coated with plain PET.

### Degradation and Removal of PET Coating

The coated paper was cut into rectangular pieces of about 0.5 g and 1×½″ in size. The PET composite films were degraded in sealed bottles of water for varying amounts of time. This was done at 90° C. in order to speed up the reaction and allow significant enough degradation to occur within a reasonable time frame.

In each bottle, 20 g of DI water was measured. The bottles were sealed and placed in the oven until reaching 90° C. One coated paper sample was placed in each bottle. The films were allowed to degrade for 1 hour, 4 hours, and 2 days. The samples were not stirred or agitated during soaking. After soaking for the desired amount of time, one sample each of the plain and degradable PET was removed. An attempt was then made to separate the paper and polymer layers by peeling them apart.

### Results

After 1 hour, both PET layers became somewhat brittle, the degradable PET a bit more so. When the two layers were peeled apart, much of the fibers remained stuck to the PET surface in both cases, representing a significant loss of yield. The plastic could be scraped with a metal tool to remove the fibers, but this required considerable effort in both cases. Within this timeframe, there was little difference between the two. After 4 hours, the plain PET showed no change, and the fibers remained strongly adhered. The degradable PET became a bit more brittle and fragmented into smaller pieces, but there was no significant change in the amount of fibers that remained adhered. FIG. 24A-FIG. 24B shows the separation of the paper and plastic layers for both the plain and degradable PET after 4 hours. In the images, the PET is being peeled away to the right, while the remaining paper substrate is on the left. Overall, in this timeframe, the plain and degradable PET behaved very similarly, and the amount of fibers left behind on the plain and degradable PET are comparable.

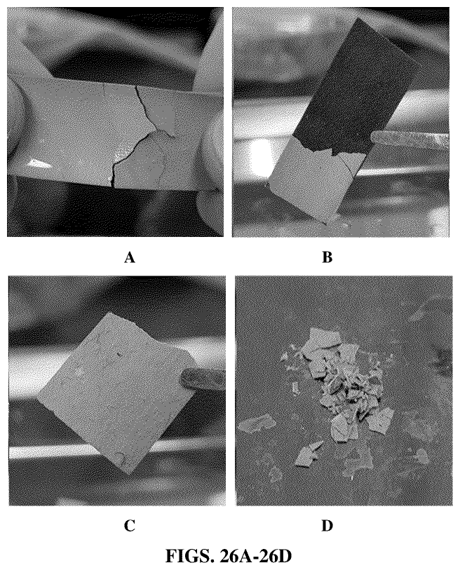

The coated paper samples were then soaked for 2 days at 90° C. During these longer experiments, no change was observed in the PET, except perhaps becoming slightly more brittle. The separation of the plain PET from the paper substrate is shown in FIG. 25A-FIG. 25C. In the first image, the two layers were peeled apart, but since they are still strongly adhered, the paper itself is torn. In the second image, the paper is visibly thinner from the loss of fibers, and in the third, the back of the plastic layer is seen to be completely covered with the paper.

Meanwhile, the degradable PET was significantly weaker, easily breaking into fragments and falling away from the paper, as shown in FIG. 26A-FIG. 26D. At this point, the surface degradation which had occurred was significant enough to deteriorate the adhesion between the paper and plastic. The degradable PET was able to be easily removed, with only a few paper fibers visible on the surface. This can be seen in the third image in the figure. In the next image, this piece of PET was crushed into smaller fragments using a pair of tweezers. If this material were to be exposed to the shear stresses present in a hydropulper, it would easily be reduced to small fragments. The paper itself also remained in nearly perfect condition, with no PET remaining on the surface and no obvious degradation of the paper.

### Discussion

This example demonstrated the ability of the degradable PET to be completely removed from a paper substrate. The degradation reaction occurred on the surface of the film, and since water is able to penetrate the paper, it is able to reach the adhered PET surface in order to initiate degradation. When the outer layer of that PET, which is adhered to the paper, degraded, the adhesion was broken, and the two layers were able to fully separate. Another unique feature of this material was that, as it degraded, it became brittle and fragments, rather than becoming soft and sticky like an adhesive as the molecular weight is reduced. This may make this material uniquely suited for facile and scalable separation from a paper substrate.

If paper coated with degradable PET were placed in a commercial recycling process, and if it could be given enough time to degrade and separate, a higher yield of paper fibers could be achieved. The shear stresses induced in the hydropulper would likely break the PET into very small fragments. Since PET is denser than water, with a specific gravity of 1.3, these fragments would likely be removed in the centrifugal cleaning step that eventually follows. The material could potentially be recovered and recycled separately to create new PET, or the hydrolysis products could likely be biodegraded.

### Conclusions

An alternative application of degradable PET was explored herein, where it can be applied as a coating to paper with the intent of being easily removed from the paper simply by soaking the entire sample in water. This can be utilized in order to improve the yield of fibers in a recycling process. The PET was able to degrade at the interface when exposed to water for long enough periods of time, and since this material became brittle and fragmented, it easily fell away from the paper and was separated in a centrifugal cleaner. In this case, with 20% CaO composite coatings, 2 days was sufficient for complete separation, although this time could be greatly reduced with higher CaO concentration, thinner coatings, and a higher fraction of solids during soaking. This represents a promising area for future work, where the degradation reaction can be optimized in order to create an efficient and scalable procedure for the removal of a degradable PET coating from a paper substrate.

### Example 4: Development of a Kinetic Model for Degradation of PET/CaO Composite Films

### Introduction

Herein, various characterization and testing techniques were used to explore the mechanism by which PET is able to latently degrade with the addition of CaO and exposure to water. Information gathered included the percentage of PET remaining in the solid samples after partial degradation estimated using TGA. The wt % of PET provided a clear metric by which to track the degradation and develop a kinetic model to describe the degradation of these films based on key parameters, including the concentration of CaO, the amount of PET relative to the water, and the surface area of the films.

For the calculations herein, the undesirable side reactions are largely ignored. It is assumed that CaTP and ethylene glycol (EG) are the only products of the reaction, and these do not in turn react with any other species. While these reactions could be taking place, they are not believed to significantly affect the degradation of PET, and ignoring them does not prevent the kinetic model from predicting the degradation behavior of PET.

This model provided an understanding of how the degradation of PET composite films progresses, as well as fully described aspects and behaviors of the system. This model details the features which distinguish this latent hydrolysis reaction from the more conventional, previously studied alkaline hydrolysis reactions.

### Development of Kinetic Model for Latently Degradable PET

This is a complex reaction medium involving multiple reactions, heterogeneous reactions, and mass transfer limitations, assumptions and simplifications were made in order to be able to express it mathematically. First, the hydration of CaO and the depolymerization of PET are both assumed to be irreversible. For both, this is a valid assumption based on the thermodynamics of the reactions, especially at the temperatures investigated here. The dissolution of Ca(OH)₂ was still considered to be reversible, in order to take into account the partial solubility of Ca(OH)₂ in water. Parallel reactions are also neglected here, including the formation of products such as acetaldehyde, 1,4-dioxane, and IPA. This is an especially valid assumption, given that alkaline hydrolysis shows high selectivity for the desired product, and evidence suggests that this is more so the case when calcium is used.

Any further reactions with EG are also not considered here. There is a possibility for subsequent reactions to occur, such as between EG and CaO, but this is not believed to be significant or to interfere with the reactions of interest. Next, the thermal degradation of PET is assumed to be negligible, even at the higher temperatures investigated here. It is assumed that hydrolysis is the only reaction that breaks the ester linkages of PET. Lastly, it was assumed that CaTP is present in the system as a solid, and that the amount of dissolved CaTP is negligible. Little solubility data is available for this chemical, but what is available suggests that only trace amounts of non-alkali metal terephthalate salts were able to dissolve in water, and it is largely present in the system as a solid.

Based on the proposed reactions and assumptions of irreversibility, the following rate equations was written, where c_{EL} refers to the molar concentration of PET ester linkages in the solid film.

r₁=k₁c_{CaO}

r₂=k₂c_{Ca(OH)2}−k₋₂c_{Ca2}+c_{OH—}²

r₃=k₃c_{EL}ⁿ^{₁}c_{OH—}ⁿ^{₂}

In the above rate equations, the concentration of water is assumed to be constant and is not included as its own parameter. r₁ and r₂ have been previously established to be simple, elementary reactions, with reaction orders corresponding to stoichiometric coefficients. The reaction orders of r₃, however, are unknown, and are designated as n₁ and n₂. Other than n₁ and n₂, there are three unknown parameters which must be solved for: k₁, k₂, and k₃. k₋₂ is related to k₂ by the solubility product constant, Kₛₚ, for the dissolution of Ca(OH)₂.

The rates were defined on the basis of surface area (mol/day/cm²), so they were multiplied by the total surface area of the film. Each of the reactions occurred between the solid and water, and was dependent on the surface area, so this surface area is multiplied by the sum of the reaction rates. In the case where the shrinking core model was not used, this was simply the initial surface area, which remained constant. In the case with the shrinking core model, this was an effective surface area which must be defined.

$$\frac{d {N}_{CaO}}{d t} = - {r}_{1} * S$$

$$\frac{d {N}_{C a ( O H ) 2}}{d t} = ( {r}_{1} - {r}_{2} ) * S$$

$$\frac{d {N}_{O H -}}{d t} = 2 * ( {r}_{2} - {r}_{3} ) * S$$

$$\frac{d {N}_{E L}}{d t} = - {r}_{3} * S$$

$$\frac{d {N}_{C a T P}}{d t} = {r}_{3} * S$$

The concentrations of the solid species are defined as mole fractions, as shown in equations below, where species x was the PET ester linkages, CaO, Ca(OH)₂, or CaTP. The hydroxide ion concentration is the molarity.

$${c}_{x} = \frac{{N}_{x}}{{N}_{E L} + {N}_{CaO} + {N}_{C a ( O H ) 2} + {N}_{C a T P}}$$

$${c}_{O H -} = \frac{{N}_{O H -}}{{V}_{H 2 O}}$$

This model was investigated both with and without the addition of the modified shrinking core model to account for changes in the effective surface area of the films, in order to determine if this offers a significant improvement. Since the surface area of the films was considered to be constant, the change in surface area due to changing geometry was not considered. Only the decrease in the effective surface area due to deposition of the solid product on the surface was considered. To do this, the effective surface area was defined by the equation below, where S_{E} is the effective surface area, S₀ is the initial surface area, X is the conversion of PET, and a is a constant that may range from 0 to 1, depending on how strongly the reaction rate depends on the PET conversion.

S_{E}=S₀(1−X)^{a}

The shrinking core model was evaluated for the case where a=1, while the kinetic model with no shrinking core is effectively the case where a=0. In this way, the full range of the modified shrinking core model was considered to see if the model might be improved by its inclusion.

### Method of Fitting Kinetic Parameters

Since the clearest results were seen from the degradation of 30 and 20% CaO/PET films at 20° C., these data were used as the basis to determine the reaction parameters.

Microsoft Excel was used to fit the model to the experimental data. The Euler method was used to solve the differential equations in order to predict the changes in concentrations of each species over time. The rate of change in the number of moles of each species involved in the reactions was related simply to the defined rate equations by stoichiometry. Step sizes of 0.1 days were used. The number of moles at the proceeding time step were calculated using the equation below. This was repeated in order to predict the moles of each species throughout the entire reaction. The conversion of PET was calculated to be compared with the experimental values obtained from TGA. The sum squared error (SSE) between the experimental and predicted conversion values was calculated. The Excel GRG nonlinear solver was used to minimize the SSE by changing k₁, k₂, and k₃.

$${N}_{x , i + 1} = {N}_{x , i} + \frac{d {N}_{x , i}}{d t} ( Δ t )$$

Several initial guess values were used for the three unknown reaction parameters. Since this is a rather complex system with multiple reactions and many local minima that could be found using the Excel solver, the best fit to the experimental results had to be determined (16) through a method of trial and error, testing a variety of inputs while taking into account whether the model predicted an adequately long induction period at the beginning of the reaction, if the Ca(OH)₂ concentration rose and fell in alignment with what was seen in the FTIR results, as well as if the predicted OH— concentration in the water matched the measured pH of the water from the degradation experiments.

Similarly, this process was used to determine the appropriate reaction orders of the third reaction, with respect to both the concentration of PET ester linkages in the solid and OH— ions in the water. In order to determine the reaction orders of r₃, it would have been ideal to manipulate the rate equations in order to obtain a relationship between PET conversion and time, then linearize that equation in order to see which reaction order provided the closest fit with experimental results. With multiple reactions in series, however, linearization was considered to be too complex, and n₁ and n₂ were instead changed by hand. The fit to experimental results was evaluated by comparing the predicted PET conversion to experimental values by eye, observing the overall fit as well as other details such the induction period at the beginning of the reaction and the behavior of Ca(OH)₂ and OH⁻ intermediates in order to determine which reaction orders most closely matched experimental results. When this was done in conjunction with the use of various initial guesses for the kinetic parameters, the entire set of reaction parameters was determined.

### Results

### Evaluation of Shrinking Core Model

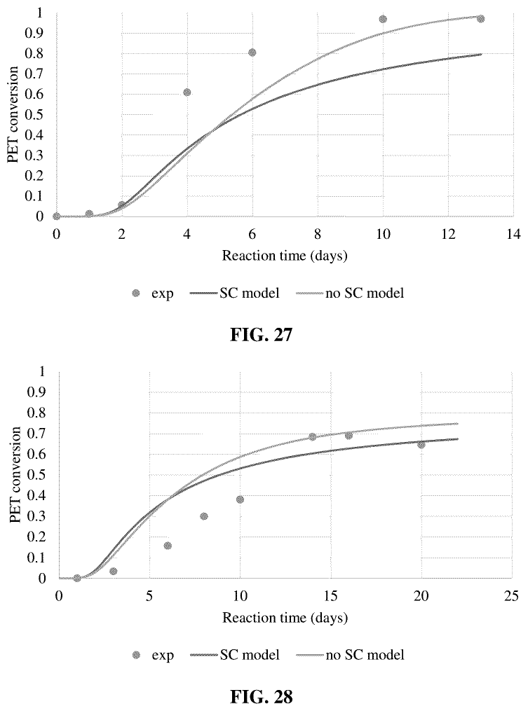

The PET conversion over time was predicted using both the simple kinetic model and the modified shrinking core model. These are plotted in FIG. 27 and FIG. 28. The best fit was achieved with n₁=1 and n2=3.

Generally, the model underpredicts the degradation rate for the 30% CaO films and overpredicts it for the 20% CaO films. This discrepancy was ameliorated by increasing the reaction order with respect to OH⁻ but increasing this value further past 3 did not improve the fit.

Comparing the kinetic model with the modified shrinking core versus without, it does not seem that its inclusion offers any improvement. The shrinking core model predicts more of a gradual decline in the reaction rate as the PET is consumed, which does not exactly align with what is seen experimentally. Since the concentration of PET is defined as a fraction of the solid species, which includes the CaTP product, the simple model without a shrinking core seems to already adequately consider the inhibiting effect of CaTP. Based on this, the modified shrinking core model was determined not to be a necessary addition, and it was not considered further. The final kinetic constants for the simplified model are shown in Table 4.

TABLE 4
Calculated kinetic constants.

| Parameter | Value | |
|---|---|---|
| n₁ | 1 | |
| n₂ | 3 | |
| k₁ | 3.89*10⁻⁴ | mol/day/cm² |
| k₂ | 2.19*10⁻⁵ | mol/day/cm² |
| k−₂ = Kₛₚ/k₂ | 3.97 | mL³/mol²/day/cm² |
| k₃ | 1.04*10⁸ | mL³/mol²/day/cm² |

### Prediction of Intermediate Species Concentrations

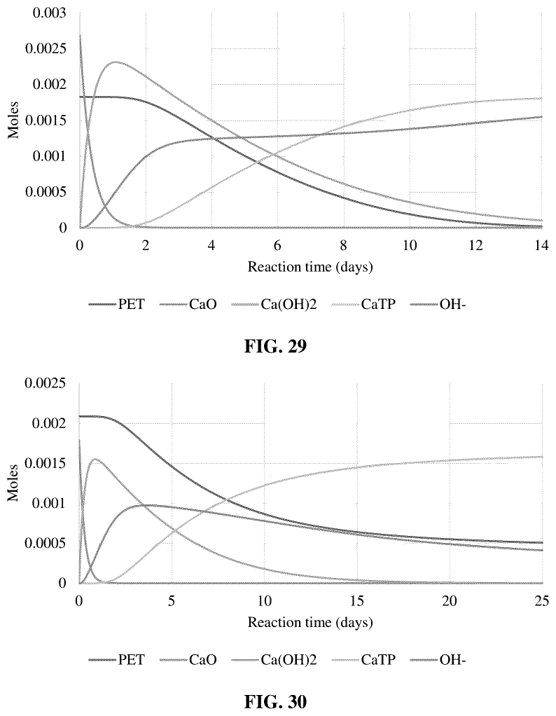

The model was used to predict the change in the number of moles for each key species, based on the initial film sample size of 0.5 g. This is shown in FIG. 29 and FIG. 30 for the 30 and 20% CaO films. In both cases, the PET does not begin degrading until around day 2. During this period, the CaO is rapidly converted to Ca(OH)₂, and this reaction is complete after about 1 day. Because of this, the highest Ca(OH)₂ concentration is seen after 1 day of degradation. This then decreases until the concentration falls below detectable limits. The behavior of Ca(OH)₂ predicted by this model corresponds with what was observed in FTIR testing of the films. In the FTIR spectra, the largest hydroxyl group peak was seen after 1 day, after which it diminished quickly and disappeared. This peak was significantly larger for the 30% and took slightly longer to disappear (3 days instead of 2). The results from FTIR are qualitative, and it is not clear what the lower limit of detection is for this species, but the model is at least able to predict the general behavior of Ca(OH)₂ well, including the differences when different CaO concentrations are used.

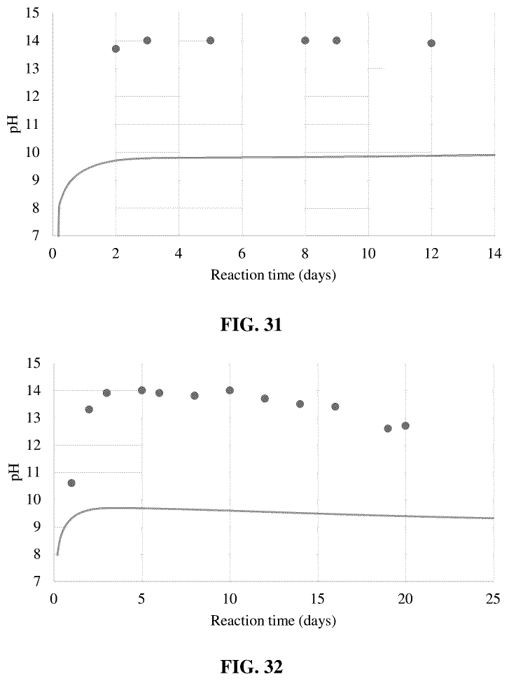

Since the model also predicts the hydroxide ion concentration throughout the course of the reaction, this may also be compared with the measured pH of the water. This is shown in FIG. 31 and FIG. 32 for both CaO concentrations. For both concentrations, the model predicts a rapid increase within the first 2 days followed by a long period of a nearly constant pH between 9 and 10. Experimentally, the pH was seen to reach 14, which is a significant discrepancy. Despite this, the model still predicts the general behavior of the pH as the reaction progresses. For the 30% CaO films, the pH is expected to remain constant, and even increase slightly, as the degradation of PET nears completion and the excess hydroxide ions accumulate in the water. This matches with the experimental observations, where the pH remained nearly constant for the duration of the reaction.

Alternatively, for the 20% CaO films, the pH shows a gradual decline throughout the course of the reaction, as the hydroxide ions are consumed in hydrolysis. Despite the much higher experimental pH values, the general behavior still tracks well with the model.

Dependence on PET/water ratio Since the hydrolysis reaction is dependent on the accumulation of hydroxide ions in the water, the volume of water is known to be a key parameter. Therefore, the model should be able to predict the degradation of the films for various PET/water ratios.

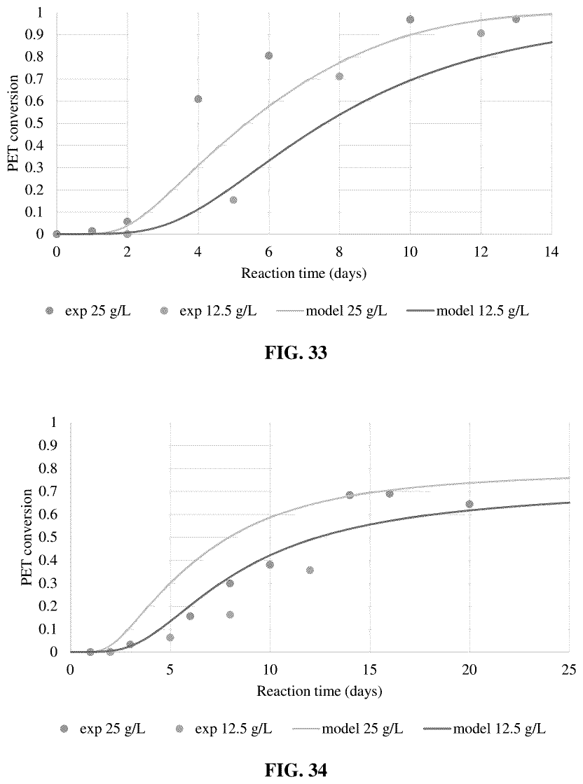

The model was evaluated for a lower PET/water ratio, where 0.25 g composite samples were used instead of 0.5 g for the same amount of water. The models for both PET/water ratios are plotted in FIG. 33 and FIG. 34 alongside experimental results. In both cases, the decrease in degradation rate predicted by the model appears to be comparable to the decrease that was seen experimentally, with the degradation rate being significantly slowed in a more diluted environment.

### Predicted Effects of System Parameters

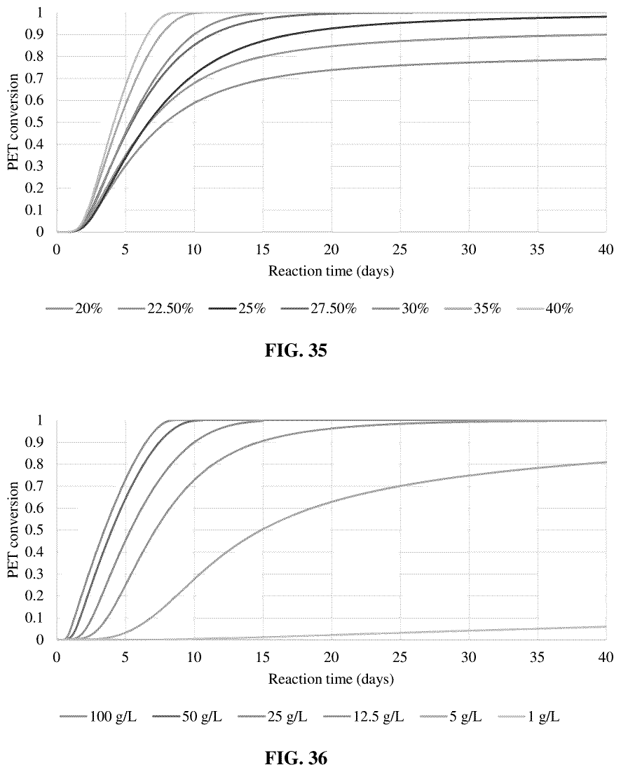

Despite differences between the model and experimental results, it may still provide some insight on how best to formulate the composites. The PET conversion is plotted over time for several CaO concentrations in FIG. 35, assuming the same surface area and PET/water ratio that were used in the experiments. All CaO concentrations of 25% or less exhibit a slow approach toward complete hydrolysis after the majority of PET is consumed within the first 2 weeks. Although the 22.5% and 25% films contain enough CaO to be able to react completely, there is not enough to efficiently drive the reaction to completion. Therefore, composites with more than 25% CaO can provide for more efficient degradable films. This is dependent on the system, however, as the degradation is also dependent on factors such as film thickness and the volume of water.

A notable detail was that the induction period of the reaction appeared to be unaffected by the CaO concentration. Within the range of concentrations shown here, each film requires about two days for the PET to begin to convert into CaTP. It is after this point that higher loadings of CaO are seen to accelerate hydrolysis. Since this material undergoes multiple reactions in series in order to degrade, there is an induction period which may allow for a sort of grace period, where the material could be used in the presence of water without undergoing extensive degradation.

The effect of PET/water ratio was similarly evaluated. The PET conversion for different ratios is shown in FIG. 36. 25 g/L was primarily investigated here, with some points obtained for 12.5 g/mL. There is a wide range of conditions that the material was exposed to, whether it is intentionally degraded in a recycling process, where the amount of water was tightly controlled, or lost in the environment, where the system is open and unregulated. By increasing the solids ratio, the water is able to become more alkaline, and more quickly. The induction time is reduced, as well as the overall reaction time. To achieve fast degradation kinetics, it is advantageous to use less water, as long as it is still in excess, in order to satisfy the assumption that the concentration of water remains constant throughout the reaction.

In the other direction, larger volumes of water were also investigated. Around 5 g/L, the reaction is slowed significantly. The dilution of the alkaline environment decreases the driving force for the depolymerization reaction, particularly in the later stages of the reaction as the hydroxide ions are consumed. As the solids ratio drops to 1 g/L, the rate is slowed until only about 5% conversion can be achieved in 40 days. In the cases with very large volumes of water, such as what might be seen if this material were to be lost in the environment, it is believed that the CaO would simply react with the water and dissolve, with very little subsequent reaction with the PET. In a larger volume of water, where the hydroxide ions cannot accumulate and concentrate, degradation cannot occur.

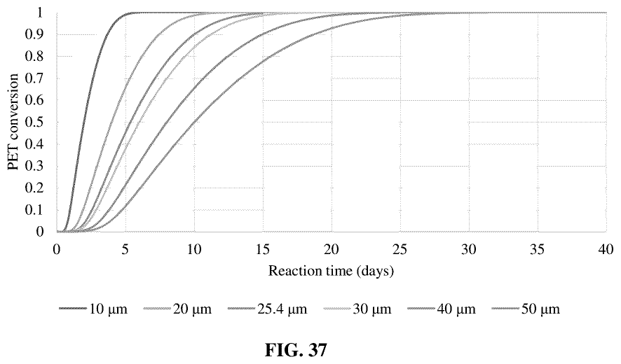

The model is able to predict the effects of changing the film thickness, since this thickness is related to the surface area. A range of thicknesses from 10 to 50 μm was evaluated and plotted in FIG. 37. The amount of PET relative to the water is constant, but since the thinner films have an increased surface area, they predictably degrade much faster, possibly in a fraction of the time that was seen this work. Similar to the PET/water ratio, the film thickness may affect the induction time. With a larger surface area available for reaction with the water, the first steps of the reaction are able to occur more quickly, and depolymerization can happen sooner. The depolymerization rate is similarly affected by the thickness, but each film is still able to fully hydrolyze within a reasonable timeframe, since the equilibrium state of the reaction is not affected.

### Discussion

Overall, the results of this example have shown that the latent degradation of a PET composite containing CaO as an alkaline reagent can be used as the basis for the development of a kinetic model. Because of this series of reactions, the PET does not actually begin to degrade until after about 2 days submerged in water, even at a higher CaO concentration of 30%. The material shows greater resistance to degradation at the beginning, but is still able to efficiently hydrolyze, given that there is enough CaO available.

For this system, it was determined that a modified shrinking core model was not necessary in order to take into account the effect of CaTP deposition on the reaction rate. Instead, by defining the concentrations of the solid species as mole fractions of the total solids, the inhibiting effect of CaTP was sufficiently considered. This differs from many kinetic models of conventional alkaline hydrolysis with a NaOH or KOH solution, where pure PET is used and its “concentration” in the rate equation is defined in terms of surface area or relative to the amount of water in the system, rather than being expressed as a fraction of a mixture of solid species. Because of this, the simpler kinetic model with no shrinking core was considered to be adequate for describing this system.

Some discrepancies were seen between the model and experimental results. It predicted a slower degradation rate for the 30% CaO films than what was seen experimentally, and faster for the 20% CaO films. The predicted pH was also lower than in experiments.

From this, the model could still be used to gain insight into the system in order to estimate the amount of CaO required to efficiently hydrolyze the PET, which is greater than the stoichiometric requirement. It also showed that the degradation rate was further accelerated with higher CaO loadings above 30%, although this comes with a trade-off in mechanical properties, since high loadings of CaO result in weak, brittle composites. Therefore, a kinetic model such as this would need to be used in conjunction with information about the mechanical performance of these composites.

By evaluating the effects of other system parameters, PET/water ratio and film thickness, it was seen that different phases of the degradation were impacted by controlling different parameters. The film thickness and PET/water ratio were both seen to affect the length of the induction period, but it was the CaO concentration and PET/water ratio which affected the ability to achieve full hydrolysis. If it is desired to be able to use this material for short-term water resistance, yet still be able to fully hydrolyze it later on, the system parameters could be optimized in order to maximize the induction period while maintaining acceptable overall reaction kinetics. In this investigation, these effects were not extensively tested, so future investigation into these degradation conditions may help to further validate or disprove the proposed mechanism.

The effect of the PET/water ratio also highlights the fact that, like any other degradable or biodegradable plastic, certain conditions are required in order to achieve degradation, and outside of those conditions, it is functionally the same as any other plastic. In the case of this degradable PET, it must be consistently submerged in a small enough volume of water in order to create a sufficiently concentrated alkaline environment. If the volume of water is too great, the CaO may simply convert to Ca(OH)₂, dissolve, and diffuse away from the unreacted PET. It is unclear how this would progress with respect to the formation of plastic fragments and microplastics, but it highlights the fact that any degradable material such as this comes with its own requirements for responsible use and disposal.

### Conclusions

Overall, the rate equations which have been developed in this example were used to mathematically describe the behavior of the key species in the latent degradation of PET, as well as the effect of key system parameters. A relatively simple model was found to be adequate, where the surface area was assumed to be constant, since its prediction of the generation and consumption of different species seems to match with what was seen experimentally, and it is able to provide a logical explanation for the observed trends. By using the model to extrapolate to conditions which were not explored in this thesis, it was shown that different aspects of the reaction can be controlled, and requirements exist for being able to fully hydrolyze the PET. These trends are exploratory at this point and should be investigated further in the future, but this contribution may offer some guidance for organizing these future studies. Ultimately, a thorough understanding of the mechanism and how to control it will allow for the optimized formulation of composite films and the knowledge for how to responsibly dispose of them after their use.

### Example 5: Pulp Recovery

Samples of compression-molded catalyzed PET were prepared with cellulosic linerboard grade paper at various catalyst addition levels. The results showed that a paper lined with a polyethylene calcium-oxide film was broken down and separated into components. Upon separation, an effective weight of 20.5 g of pulp was retrieved with no need for additional separation. This came from 3 samples, one from each of the oxide levels (20%, 25%, and 30%). The three calcium oxide groups, 20%, 25%, and 30% concentration, were weighed out into 20 g batches. These batches were mixed with water to make a 5% solution (requiring 700 g water) and blended for one minute.

From there, the samples were added to the Sommerville shive separator unit with a 900 screen (the finest screen available). Pulp was captured through the screen, while the rejects remained on the screen. These masses were then left to dry for a week and then weighed.

TABLE 5
Data regarding pulp recovery of each sample
based on percent composition of oxide.

| Oxide | Pulp | Re- | Recov- | |
|---|---|---|---|---|
| Percent- | Recovered | jects | ery | |
| age | (g) | (g) | (%) | Notes |
| 0 wt % | 4 | 16 | 20 | |
| 20 wt % | 13 | 7 | 65 | Rejects were still slightly damp. |
| | | | | Consisted mostly of plastic |
| | | | | particles |
| | 19 | 1 | 95 | Pulp was very slightly damp. |
| | | | | Rejects were solid conglomerate |
| | | | | of plastic connected by paper |
| | | | | fibrils |
| 25 wt % | 16 | 4 | 80 | Lots of plastic particulates |
| 30 wt % | 15.5 | 4.5 | 77.5 | Slightly damp rejects but mixed |
| | | | | very fine. Paper fibrils acted |
| | | | | like a woven material, more |
| | | | | noticeable than in other finely |
| | | | | blended rejects. |

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

### REFERENCES

Hiraga, K., Taniguchi, I., Yoshida, S., Kimura, Y., Oda, K. Biodegradation of waste PET: A sustainable solution for dealing with plastic pollution. EMBO reports. 20, 11. (2019).
Shajaei, B., Abtahi, M., & Najafi, M. Chemical recycling of PET: A stepping-stone toward sustainability. Polymers for Advanced Technologies. (2020).
Sinha, V., Patel. M., Patel. J. PET Waste Management by Chemical Recycling: A review. Journal of Polymers and the Environment. 18. 1. (2010). Li, Y., Scale-Up Synthesis of High Purity Calcium Terephthalate from Polyethylene Terephthalate Waste: Purification, Characterization, and Quantification. Macromolecular Materials and Engineering. (2021).
“250 billion cups of opportunity,” https://www.nextgenconsortium.com/about.
Scaffaro, R., Maio, A., Sutera, F., Gulino, E. F., & Marreale, M. (2019). Degradation and Recycling of Films Based on Biodegradable Polymers: A Short Review. Polymers, 11(651). doi:10.3390/polym11040651
Kumagai, S., G. Grause, T. Kameda, et al., Simultaneous Recovery of Benzene-Rich Oil and Metals by Steam Pyrolysis of Metal-Poly(ethylene terephthalate) Composite Waste. Environmental Science & Technology 48(6): p. 3430-3437. (2014).
Du, S. C., J. A. Valla, R. S. Parnas, et al., Conversion of Polyethylene Terephthalate Based Waste Carpet to Benzene-Rich Oils through Thermal, Catalytic, and Catalytic Steam Pyrolysis. ACS Sustainable Chemistry & Engineering. 4(5): p. 2852-2860. (2016).
Scheirs, J., & Long, T. E. (2006). Modern polyesters: Chemistry and technology of polyesters and copolyesters. John Wiley & Sons.
EPA. (2022, September 19). Fact and Figures about Materials, Waste and Recycling. EPA. Retrieved Oct. 17, 2022, from https://www.epa.gov/facts-and-figures-about-materials-waste-and-recycling/plastics-material-specific-data
Parker, L. (2021, May 3). Plastic pollution facts and information. Environment. Retrieved Oct. 18, 2022, from https://www.nationalgeographic.com/environment/article/plastic-pollution
Wang, J., Tan, Z., Peng, J., Qiu, Q., & Li, M. (2016). The behaviors of microplastics in the Marine Environment. Marine Environmental Research, 113, 7-17. https://doi.org/10.1016/j.marenvres.2015.10.014
Scholz, C. (2012). Degradable Polymers and Materials: Principles and Practice (2nd edition). (K. Khemani, Ed.) (Ser. ACS Symposium Series). Oxford University Press.
Shojaei, B., Abtahi, M., & Najafi, M. (2020). Chemical recycling of PET: A stepping-stone toward sustainability. Polymers for Advanced Technologies, 31(12), 2912-2938. https://doi.org/10.1002/pat.5023
Rabnawaz, M., Wyman, I., Auras, R., & Cheng, S. (2017). A roadmap towards Green Packaging: The current status and future outlook for polyesters in the packaging industry. Green Chem., 19(20), 4737-4753. https://doi.org/10.1039/c7gc02521a
Bedard, L., Matta, T., & Thompson, L. (2021, February). Addressing the Challenge of Film and Flexible Packaging Data. The Recycling Partnership.
The Last Beach Cleanup, & Beyond Plastics. (2022). The Real Truth About the U.S. Plastics Recycling Rate.
Moore & Associates. (2022, January 27). The State of Paper Cup Recycling.
Geyer, B., Lorenz, G., & Kandelbauer, A. (2016). Recycling of poly(ethylene terephthalate)—a review focusing on chemical methods. Express Polymer Letters, 10(7), 559-586. https://doi.org/10.3144/expresspolymlett.2016.53
Lipik, V. T., & Abadie, M. J. (2007). Polyethylene terephthalate chemical recycling in the melted state. Polymer-Plastics Technology and Engineering, 46(7), 695-701. https://doi.org/10.1080/15583720701271518
Li, Y., Chen, J., Han, W., Yi, H., Wang, J., Xing, P., Ren, J., & Yao, D. (2022). Toward making poly(ethylene terephthalate) degradable in aqueous environment. Macromolecular Materials and Engineering, 307(4), 2100832. https://doi.org/10.1002/mame.202100832
Ghosh, K., & Jones, B. H. (2021). Roadmap to biodegradable plastics—current state and research needs. ACS Sustainable Chemistry & Engineering, 9(18), 6170-6187. https://doi.org/10.1021/acssuschemeng.1c00801
Yang, Q., Wu, Z., & Tao, C. (2013). Study on biodegradability of terephthalic acid in polyester fabric alkali-peeling process wastewater. Water Science and Technology, 69(2), 328-334. https://doi.org/10.2166/wst.2013.714
OECD. (2022, February 22). Plastic pollution is growing relentlessly as waste management and recycling fall short, says OECD. Retrieved Nov. 8, 2022, from https://www.oecd.org/environment/plastic-pollution-is-growing-relentlessly-as-waste-management-and-recycling-fall-short.htm
Sinha, V., Patel, M. R., & Patel, J. V. (2008). Pet waste management by Chemical Recycling: A Review. Journal of Polymers and the Environment, 18(1), 8-25. https://doi.org/10.1007/s10924-008-0106-7
Karayannidis, G. P., & Achilias, D. S. (2007). Chemical recycling of poly(ethylene terephthalate). Macromolecular Materials and Engineering, 292(2), 128-146. https://doi.org/10.1002/mame.200600341
López-Fonseca, R., González-Velasco, J. R., & Gutiérrez-Ortiz, J. I. (2009). A shrinking core model for the alkaline hydrolysis of pet assisted by tributylhexadecylphosphonium bromide. Chemical Engineering Journal, 146(2), 287-294. https://doi.org/10.1016/j.cej.2008.09.039
Mishra, S., & Goje, A. S. (2003). Chemical Recycling, kinetics, and thermodynamics of alkaline depolymerization of waste poly (ethylene terephthalate) (PET). Polymer Reaction Engineering, 11(4), 963-987. https://doi.org/10.1081/pre-120026382
Li, Y., Yi, H., Ge, M., & Yao, D. (2021). Scale-up synthesis of high purity calcium terephthalate from polyethylene terephthalate waste: Purification, characterization, and quantification. Macromolecular Materials and Engineering, 306(12), 2100591. https://doi.org/10.1002/mame.202100591
Li, Y. Y., Yao, D. G., & Ge, M. Q. (2021). Reactive melt processing of poly(ethylene terephthalate) waste into calcium terephthalate. Express Polymer Letters, 15(2), 153-165. https://doi.org/10.3144/expresspolymlett.2021.14
Aharoni, S. M. (1984). Nucleation of PET Crystallization by Metal Hydroxides. Journal of Applied Polymer Science, 29(3), 853-865. https://doi.org/10.1002/app.1984.070290314
Wan, B.-Z., Kao, C.-Y., & Cheng, W.-H. (2000). Kinetics of depolymerization of poly(ethylene terephthalate) in a potassium hydroxide solution. Industrial & Engineering Chemistry Research, 40(2), 509-514. https://doi.org/10.1021/ie0005304
Deng, Z., Schweigerdt, A., Norow, A., & Lienkamp, K. (2019). Degradation of polymer films on surfaces: A model study with poly(sebacic anhydride). Macromolecular Chemistry and Physics, 220(15), 1900121. https://doi.org/10.1002/macp.201900121
Fogler, H. S. (2005). Elements of chemical reaction engineering. Pearson Education Internat.
Yoshioka, T., Okayama, N., & Okuwaki, A. (1998). Kinetics of hydrolysis of pet powder in nitric acid by a modified shrinking-core model. Industrial & Engineering Chemistry Research, 37(2), 336-340. https://doi.org/10.1021/ie970459a
Wang, Y., Kretschmer, K., Zhang, J., Mondal, A. K., Guo, X., & Wang, G. (2016). Organic sodium terephthalate graphene hybrid anode materials for sodium-ion batteries. RSC Advances, 6(62), 57098-57102. https://doi.org/10.1039/c6raI1809g
Kumagai, S., Grause, G., Kameda, T., & Yoshioka, T. (2014). Simultaneous recovery of benzene-rich oil and metals by steam pyrolysis of metal-poly(ethylene terephthalate) composite waste. Environmental Science & Technology, 48(6), 3430-3437. https://doi.org/10.1021/es405047j
Galván-Ruiz, M., Hernández, J., Baños, L., Noriega-Montes, J., & Rodríguez-García, M. E. (2009). Characterization of calcium carbonate, calcium oxide, and calcium hydroxide as starting point to the improvement of lime for their use in construction. Journal of Materials in Civil Engineering, 21(11), 694-698. https://doi.org/10.1061/(asce)0899-1561(2009)21:11(694)
Kumagai, S., Grause, G., Kameda, T., & Yoshioka, T. (2014). Catalytic degradation of poly(ethylene terephthalate) for benzene-rich oil recovery using metal hydroxides. Chemistry Letters, 43(5), 637-639. https://doi.org/10.1246/cl.131109
Dominici, F., Puglia, D., Luzi, F., Sarasini, F., Rallini, M., & Torre, L. (2019). A novel class of cost effective and high performance composites based on terephthalate salts reinforced polyether ether ketone. Polymers, 11(12), 2097. https://doi.org/10.3390/polym11122097
Baker, P., & Grossman, R. F. (1989). Properties and Reactions of Metal Terephthalates. Journal of Vinyl Technology, 11(2), 59-61. https://doi.org/https://doi.org/10.1002/vnl.730110204

What is claimed is:

1. A composition comprising:
a first layer having a first surface and a second surface and comprising a cellulosic material, wherein the first layer has a first thickness; and
a second layer having a first surface and a second surface, wherein the second surface of the second layer overlays the first surface of the first layer, wherein the second layer comprises a first compound comprising a first polymer and a first metal oxide, and wherein the second layer has a second thickness.

2. The composition of claim 1, wherein the first polymer comprises a polyolefin, a polyamide, a polyester, or any combination thereof.

3. The composition of claim 1, wherein the first metal oxide is selected from CaO, Na₂O, K₂O, Li₂O, BaO, SrO, MgO, or a combination thereof.

4. The composition of claim 1, wherein the first metal oxide is present in the first compound in a weight percentage of from 5 wt % to 50 wt % of the total weight of the first compound.

5. The composition of claim 4, wherein the composition is at least partially degradable in an aqueous environment, and wherein degradability of the composition is tunable based on the weight percentage of the first metal oxide present in the first compound.

6. The composition of claim 1, wherein the second thickness is smaller than the first thickness.

7. The composition of claim 2, wherein the polyester comprises one or more of polyethylene terephthalate, polytrimethylene terephthalate, polypropylene terephthalate, polybutylene terephthalate, copolymers thereof, and combination thereof.

8. The composition of claim 1, wherein the composition further comprises a third layer having a first surface and a second surface, wherein the second surface of the third layer overlays the second surface of the first layer, wherein the third layer comprises a second compound comprising a second polymer and a second metal oxide, and wherein the third layer has a third thickness.

9. The composition of claim 8, wherein the second compound is substantially the same as the first compound.

10. The composition of claim 8, wherein the first polymer and the second polymer are substantially the same or substantially different.

11. The composition of claim 8, wherein the first metal oxide and the second metal oxide are substantially the same or substantially different.

12. The composition of claim 8, wherein the second polymer comprises a second polyolefin, a second polyamide, a second polyester, or any combination thereof.

13. The composition of claim 12, wherein the second polyester comprises one or more of polyethylene terephthalate, polytrimethylene terephthalate, polypropylene terephthalate, polybutylene terephthalate, copolymers thereof, and combination thereof.

14. The composition of claim 8, wherein the third thickness is the same or different from the second thickness.

15. The composition of claim 1, wherein the composition is configured to withstand a temperature from −10° C. to up to 160° C. without substantially degrading for a predetermined period of time.

16. The composition of claim 1, wherein the composition is configured to withstand a microwave at a frequency of 2.45 GHz without substantially degrading for a predetermined period of time.

17. The composition of claim 1, wherein the composition is substantially recyclable.

18. The composition of claim 17, wherein at least 75 wt % of an original amount of the cellulosic material is recoverable.

19. The composition of claim 1, wherein the first polymer comprises polyethylene terephthalate and the first metal oxide comprises CaO.

20. The composition of claim 1, wherein the first polymer and the first metal oxide are combined via melt-mixing.

21. The composition of claim 1, wherein the cellulosic material comprises paper, cardboard, linerboard, containerboard, or any combination thereof.

22. An article comprising the composition of claim 1.

23. The article of claim 22, wherein the article comprises a sheet material, a paper, a modified paper, a tableware, a food container, a packaging, or any combination thereof.

24. The article of claim 22, wherein the article is substantially recyclable.

25. The article of claim 24, wherein the article is configured to be heated in a microwave oven, or a convection oven up to a temperature of 200° C. without substantially degrading for a predetermined period of time.

26. A method of making a composition comprising:
a) providing a first layer having a first surface and a second surface and comprising a cellulosic material, wherein the first layer has a first thickness; and
b) extruding a second layer on the first surface of the first layer, wherein the second layer comprises a first compound comprising a polymer and a metal oxide, and wherein the second layer has a second thickness.

27. A method of making an article from a recycled material comprising:
recycling the composition of claim 1 to form the recycled material, wherein the recycled material comprises the cellulosic material of the composition; and
forming the recycled material into the article.
